(19) United States
(12) Patent Application Publication
(10) Pub. No.: US 2019/0242055 A1
(43) Pub. Date: Aug. 8, 2019

(54) BLENDED CHITOSAN-LATEX BINDER FOR HIGH PERFORMANCE NONWOVEN FABRICS

(71) Applicant: Georgia-Pacific Nonwovens LLC, Atlanta, GA (US)

(72) Inventors: Abdus Salam, Huntersville, NC (US); Timothy Kistemaker, Mooresville, NC (US); Karen Marsh, Charlotte, NC (US)

(73) Assignee: Georgia-Pacific Nonwovens LLC, Atlanta, GA (US)

(21) Appl. No.: 16/083,931

(22) PCT Filed: Mar. 10, 2017
(86) PCT No.: PCT/US17/21770

§ 371 Date: Sep. 11, 2018

Related U.S. Application Data
(60) Provisional application No. 62/307,036, filed on Mar. 11, 2016.

(51) Int. Cl. D06M 15/03; C08L 5/08; D04H 1/52; D04H 1/425

(52) U.S. Cl. CPC D06M 15/03; C08L 5/08; D06M 15/227; D04H 1/425; D04H 1/52

(57) ABSTRACT

A chitosan-latex binder comprising chitosan and latex binder in a weight ratio of chitosan to latex binder of from about 1:10 to about 1:15,000. A method of making a chitosan-latex binder, the method comprising (a) contacting chitosan with an acidic solution to form a chitosan solution, and (b) contacting at least a portion of the chitosan solution with a latex binder to form the chitosan-latex binder, wherein the chitosan-latex binder is characterized by a chitosan to latex binder weight ratio of from about 1:10 to about 1:15,000.

### TECHNICAL FIELD

The present disclosure relates to binder compositions for nonwovens, more specifically latex based binders for nonwoven materials and methods of making and using same.

### BACKGROUND

Nonwovens are generally used in a wide range of consumer and industrial products with diverse properties, including healthcare and surgical fabrics, wipes, absorbent hygiene products, apparel, home furnishings, construction, filtration, engineering, etc. A nonwoven material is a sheet of fibers, continuous filaments (e.g., fiber precursors), or chopped yarns of any nature or origin, that have been formed into a web by any means, and bonded together by any means, with the exception of weaving or knitting.

Some nonwoven fabrics have sufficient web strength after forming to be handled even if they are subsequently additionally bonded, for example when a bonding step is an integral part of the web-forming process, as in spun-bond and melt-blown nonwovens. Most other webs have relatively little strength as formed and may require an additional bonding step (e.g., chemical bonding) in order to make the nonwoven web suitable for its intended end use. Chemical bonding in nonwovens products normally refers to the use of latex binders, which have been in existence at least as long as most modern nonwovens themselves. The great benefit of latex binders is their overall versatility and utility. However, latex binders are expensive and require the use of large volumes of binder to achieve the minimum target quality. Another issue during nonwoven fabric manufacturing is a high dust level, which is very tough to control with latex binders, and such dust level can pose safety and environmental concerns. Thus, there is an ongoing need for the development of improved binder compositions for nonwovens.

### BRIEF SUMMARY

Disclosed herein is a chitosan-latex binder comprising chitosan and latex binder in a weight ratio of chitosan to latex binder of from about 1:10 to about 1:15,000.

Also disclosed herein is a method of making a chitosan-latex binder, the method comprising (a) contacting chitosan with an acidic solution to form a chitosan solution, and (b) contacting at least a portion of the chitosan solution with a latex binder to form the chitosan-latex binder, wherein the chitosan-latex binder is characterized by a chitosan to latex binder weight ratio of from about 1:10 to about 1:15,000.

Further disclosed herein is a method of making a nonwoven fabric, the method comprising (a) forming a plurality of fibers into a fiber web, (b) contacting at least a portion of the fiber web with a chitosan-latex binder to form a binder impregnated fiber web, wherein the chitosan-latex binder comprises chitosan and latex binder in a weight ratio of chitosan to latex binder of from about 1:10 to about 1:15,000, and (c) curing the binder impregnated fiber web to form the nonwoven fabric.

Further disclosed herein is a nonwoven fabric comprising a fiber web in an amount of from about 85 wt. % to about 99.9 wt. %, based on the total weight of the nonwoven fabric; and a cured chitosan-latex binder in an amount of from about 0.1 wt. % to about 15 wt. %, based on the total weight of the nonwoven fabric, wherein the cured chitosan-latex binder comprises chitosan and latex binder in a weight ratio of chitosan to latex binder of from about 1:10 to about 1:15,000.

Further disclosed herein is a nonwoven fibrous material chemically bound with a latex binder modified with chitosan.

### BRIEF DESCRIPTION OF THE DRAWINGS

For a detailed description of the preferred embodiments of the disclosed methods, reference will now be made to the accompanying drawings in which:

FIG. 1 displays tensile strength values for various nonwoven fabrics treated with latex binder with and without chitosan;

FIG. 2 displays dust levels for various nonwoven fabrics treated with latex binder with and without chitosan; and

FIG. 3 displays water absorbency levels and calipers for various nonwoven fabrics treated with latex binder with and without chitosan.

FIG. 4 displays the effect of tensile strength on chitosan addition into latex binder with MBAL nonwoven fabric.

FIG. 5 displays the SEM image of EVA-192 binder addition for control sample (left) and EVA-192 binder with chitosan addition for experimental sample (right) of machine production MBAL nonwoven fabrics.

FIG. 6 displays the antimicrobial test of 6% binder addition (left) and 3% binder with chitosan addition (right) treated nonwoven fabric.

### DETAILED DESCRIPTION

Disclosed herein are chitosan-latex binder compositions and methods of making and using same. In an embodiment, a chitosan-latex binder composition can comprise chitosan and latex binder in a weight ratio of chitosan to latex binder of from about 1:10 to about 1:15,000. In an embodiment, the chitosan-latex binder composition is a sprayable aqueous emulsion.

In an embodiment, a method of making a chitosan-latex binder can generally comprise the steps of (a) contacting chitosan with an acidic solution to form a chitosan solution; and (b) contacting at least a portion of the chitosan solution with a latex binder to form the chitosan-latex binder, wherein the chitosan-latex binder is characterized by a chitosan to latex binder weight ratio of from about 1:10 to about 1:15,000.

Also disclosed herein are nonwoven fabrics and methods of making and using same. In an embodiment, a nonwoven fabric can comprise a fiber web in an amount of from about 85 wt. % to about 99.9 wt. %, based on the total weight of the nonwoven fabric; and a cured chitosan-latex binder in an amount of from about 0.1 wt. % to about 15 wt. %, based on the total weight of the nonwoven fabric, wherein the cured chitosan-latex binder comprises chitosan and latex binder in a weight ratio of chitosan to latex binder of from about 1:10 to about 1:15,000. In an embodiment, the fiber web can comprise cellulosic fibers and bicomponent fibers.

In an embodiment, a method of making a nonwoven fabric can generally comprise the steps of (a) forming a plurality of fibers into a fiber web; (b) contacting at least a portion of the fiber web with a chitosan-latex binder to form a binder impregnated fiber web, wherein the chitosan-latex binder comprises chitosan and latex binder in a weight ratio of chitosan to latex binder of from about 1:10 to about 1:15,000; and (c) curing the binder impregnated fiber web to form the nonwoven fabric, wherein the nonwoven fabric comprises a cured chitosan-latex binder, and wherein the cured chitosan-latex binder comprises at least a portion of the chitosan of the chitosan-latex binder and at least a portion of the latex binder of the chitosan-latex binder. In an embodiment, the method of making a nonwoven fabric can comprise an air-laid process.

The terms used herein generally have their ordinary meanings in the art, within the context of this disclosure and in the specific context where each term is used. Certain terms are defined below to provide additional guidance in describing the compositions and methods of the current disclosure and how to make and use them.

As used in the specification and the appended claims, the singular forms “a,” “an” and “the” include plural referents unless the context clearly dictates otherwise. Thus, for example, reference to “a compound” includes mixtures of compounds.

The term “about” or “approximately” means within an acceptable error range for the particular value as determined by one of ordinary skill in the art, which will depend in part on how the value is measured or determined, i.e., the limitations of the measurement system. For example, “about” can mean within 3 or more than 3 standard deviations, per the practice in the art. Alternatively, “about” can mean a range of up to 20%, alternatively up to 10%, alternatively up to 5%, or alternatively up to 1% of a given value. Alternatively, particularly with respect to systems or processes, the term can mean within an order of magnitude, within 5-fold, and within 2-fold, of a value.

As used herein, the term “weight percent” (wt. %) is meant to refer to either (i) the quantity by weight of a constituent or component in a material as a percentage of the weight of the material; or (ii) to the quantity by weight of a constituent or component in a material as a percentage of the weight of the final nonwoven material or product.

The term “basis weight” as used herein refers to the quantity by weight of a compound over a given area. Examples of the units of measure include grams per square meter as identified by the acronym (gsm).

As used herein, the terms “gli,” “g/in,” and “G/in” refer to “grams per linear inch” or “gram force per inch.” This refers to the width, not the length, of a test sample for tensile strength testing

As used herein, “aqueous” means water and mixtures composed substantially of water.

As used herein the terms “fiber,” “fibrous” and the like are intended to encompass materials that have an elongated morphology exhibiting an aspect ratio (length to thickness) of greater than about 100, alternatively greater than about 500, alternatively greater than about 1,000, or alternatively greater than about 10,000.

In an embodiment, a chitosan-latex binder can comprise chitosan and a latex binder in a weight ratio of chitosan to latex binder of from about 1:10 to about 1:15,000, alternatively from about 1:100 to about 1:10,000, or alternatively from about 1:1,000 to about 1:5,000.

In an embodiment, the chitosan-latex binder can comprise chitosan. Chitosan is a polysaccharide that is very abundant as a byproduct of the fishing, agriculture (mushroom), bacterial and fungal industry, is widely available and is of strong research interest. Chitosan is the N-deacetylated form of chitin that is obtained by alkaline treatment of chitin (e.g., treatment with sodium hydroxide (NaOH)) at high temperatures. Chitin is an abundant naturally occurring polysaccharide which consists mainly of β-(1-4)-2-acetamido-2-deoxy-D-glucose units. However, strong intermolecular hydrogen bonding and poor solubility in common organic solvents have so far prevented widespread utilization of chitin. For purposes of the disclosure herein, the term “chitosan” refers to the N-deacetylated form of chitin that is obtained by alkaline treatment of chitin (e.g., treatment with NaOH) at high temperature, as well as precursors of chitosan (e.g., not fully N-deacetylated), and chemical relatives and derivatives of chitosan.

Chitosan and its derivatives have become useful polysaccharides in the biomedical area because of their biocompatible, biodegradable, and non-toxic properties. Chitosan and chitosan derivatives are known to have antimicrobial and antifungal activities. Chitosan has been found to inhibit the growth of a wide variety of bacteria and fungi. Moreover, chitosan has several advantages over other types of disinfectants in that it possesses a higher antibacterial activity, broader spectra of activity, a higher killing rate, and lower toxicity toward mammalian cells. Chitosan and its properties are described in more detail in George A. F. Roberts, Chitin chemistry, Macmillan, London, 1992, 64; I. M. Helander, E. L. Nurmiaho-Lassila, R. Ahvenainen, J. Rhoades, S. Roller, International Journal of Food Microbiology, 2001, 71(2), 235; K. Y. Lee, W. H. Park, W. S. Ha, J. Appl. Polym. Sci., 1997, 63, 425; and K. F. El-Tahlawy, M. A. El-bendary, A. G. Elhendawy, S. M. Hudson, Carbohydrate Polymer, 2005, 60, 421; Sang-Hoon Lim, S. M. Hudson, Carbohydrate Polymers, 2004, 56(2), 227; each of which is incorporated by reference herein in its entirety.

In an embodiment, the chitosan-latex binder can comprise the chitosan in an amount of from about 0.01 wt. % to about 1.0 wt. %, alternatively from about 0.05 wt. % to about 0.9 wt. %, or alternatively from about 0.1 wt. % to about 0.75 wt. %.

In an embodiment, the chitosan-latex binder can comprise a latex binder. Commercially, latex polymers are the most commonly encountered binders because of their availability, variety, versatility, ease of application, and cost-effectiveness. Generally, a latex binder can be an emulsion comprising an aqueous medium with extremely fine liquid or solid polymer particles (e.g., latex polymer particles) dispersed therein. The polymer particles can be enclosed in emulsifier or surfactant micelles. The latex polymers can be prepared by aqueous emulsion polymerization via controlled addition of several components, such as monomers (e.g., vinyl monomers), comonomers, water, an initiator (e.g., a compound that decomposes to form free radicals to start a polymerization process), a surfactant (e.g., a compound that can prevent particle attraction and thus stabilize emulsion particles), an anionic surfactant, a chain transfer agent (e.g., a compound that can control the final polymer molecular weight), and the like, or combinations thereof. The resulting latex polymers can be a latex polymer emulsion. In some embodiments, the latex polymer emulsion can be dried to produce a latex polymer powder, wherein the latex polymer powder can be subsequently re-dispersed in water or an aqueous medium to form a latex binder emulsion.

In an embodiment, the latex can be selected from the group consisting of vinyl acetate ethylene binders, vinyl acetate ethylene-N-methylol acrylamide binders, acrylic binders, vinyl acrylic binders, styrene acrylic binders, acrylic-polyurethane binders, styrene-butadiene binders, carboxylated styrene-butadiene binders, and combinations thereof. Suitable latex binders are also described in more detail in Emulsion Polymers, Mohamed S. El-Aasser et al. (Editors), ISBN: 3-527-30134-8, from the 217th American Chemical Society (ACS) Meeting in Anaheim, Calif. (March 1999); and in Emulsion Polymerization and Emulsion Polymers, Peter A. Lovell et al. (Editors), ISBN: 0-471-96746-7, published by Jossey-Bass, Wiley; each of which is incorporated by reference herein in its entirety.

Nonlimiting examples of commercially available latex binders suitable for use in the present disclosure include ELITE 22 and ELITE 33 binders, which are available from Celanese Emulsions, Bridgewater, N.J. ELITE 22 and ELITE 33 binders are vinyl acetate ethylene emulsions based on the copolymerization of vinyl acetate and ethylene, in which the vinyl acetate content can range between 60% and 95%, and the ethylene content can range between 5% and 40% percent of the total polymeric formulation. Further nonlimiting examples of commercially available latex binders suitable for use in the present disclosure include AIRFLEX 124 and AIRFLEX 192, which are available from Air Products, Allentown, Pa. AIRFLEX 124 latex binder is an ethyl vinyl acetate copolymer having about 10 wt. % solids and about 0.75 wt. % anionic surfactant. AIRFLEX 124 and AIRFLEX 192 can further have an opacifier and whitener, including, but not limited to, titanium dioxide, dispersed in the latex binder emulsion. Other nonlimiting examples of commercially available latex binders suitable for use in the present disclosure include TYLAC and 68957-80 binders, which are carboxylated styrene-butadiene-acrylonitrile copolymers available from Dow Reichhold Specialty Latex LLC of Research Triangle Park, N.C.; ROVENE, which is a carboxylated styrene-butadiene rubber available from Mallard Creek Polymers, Inc. of Charlotte, N.C.; CP 615NA and CP 692NA binders, which are modified styrene butadiene latexes, and, CP6810NA which is a modified styrene acrylate latex, all of which are available from The Dow Chemical Company (Midland, Mich.); RHOPLEX and PRIMAL binders which are acrylate emulsion polymers available from Rohm and Haas (Philadephia, Pa.).

In an embodiment, the chitosan-latex binder can comprise the latex binder in an amount of from about 99.0 wt. % to about 99.99 wt. %, alternatively from about 99.1 wt. % to about 99.95 wt. %, or alternatively from about 99.25 wt. % to about 99.9 wt. %.

In an embodiment, the chitosan-latex binder can comprise water. Generally, the components used for preparing the chitosan-latex binder can comprise water, as will be described in more detail later herein, and such water is present in the chitosan-latex binder. For example, the latex binder can be an aqueous emulsion; the chitosan may be dissolved in an aqueous solution; etc.

In an embodiment, the chitosan-latex binder can be an emulsion, such as a sprayable emulsion. Generally, the chitosan-latex binder can be an emulsion comprising an aqueous medium with extremely fine liquid or solid polymer particles (e.g., latex polymer particles) dispersed therein, wherein the polymer particles can be enclosed in emulsifier or surfactant micelles, and wherein the chitosan can be bonded to the latex binder or any components thereof via any suitable bonds, such as for example an ionic bond. As will be appreciated by one of skill in the art, and with the help of this disclosure, chitosan is a polycationic compound, and as such chitosan can form ionic bonds with anionic components of the chitosan-latex binder, for example carboxylate groups of the latex binder (e.g., acetate, acrylate, etc.), anionic surfactant, etc.

In an embodiment, the chitosan-latex binder can have a pH of from about 2 to about 6, alternatively from about 2.5 to about 5.5, or alternatively from about 3 to about 5. As will be appreciated by one of skill in the art, and with the help of this disclosure, chitosan can precipitate (e.g., come out of the solution) at pH values above 6-7.

In an embodiment, the chitosan-latex binder can comprise at least one antimicrobial agent. As used herein, the term “antimicrobial” refers to drugs, chemicals, or other substances that either kill or slow the growth of microorganisms. In an embodiment, the at least one antimicrobial agent can be one or more compounds other than chitosan; the at least one antimicrobial agent can comprise chitosan; or combinations thereof. Without wishing to be limited by theory, chitosan owes antimicrobial activity to the presence of amine groups (e.g., —NH₂) in the chitosan structure, which amine groups contribute to the polycationic structure of chitosan, for example by conversion to ammonium cations.

As will be appreciated by one of skill in the art, and with the help of this disclosure, the antimicrobial activity of chitosan can be due to one or more of the following: (1) the polycationic structure of chitosan (e.g., owing to the presence of amine groups (e.g., —NH₂) in the chitosan structure, wherein —NH₂ can be converted to —NH3⁺ when chitosan is dissolved in an acidic solution) may interact with the predominantly anionic components (lipopoly-saccharides and proteins of a microorganism surface) of cell membranes resulting in changes in the membrane permeability that causes death of a cell by inducing leakage of intracellular components; (2) the chitosan on the surface of the cell can form a polymer membrane that prevents nutrients from entering the cell; (3) a lower molecular weight chitosan of can enter the cell, bind to DNA and inhibit RNA and protein synthesis; and (4) since chitosan could adsorb electronegative substances in the cell and flocculate them (e.g., owing to the polycationic structure of chitosan, which is in turn due to the presence of amine groups (e.g., —NH₂) and/or —NH3^{|} cations in the chitosan structure), chitosan may disturb the physiological activities of a microorganism leading to cell death. The antimicrobial activity of chitosan is described in more detail in I. M. Helander, E. L. Nurmiaho-Lassila, R. Ahvenainen, J. Rhoades, S. Roller, International Journal of Food Microbiology, 2001, 71(2), 235; M. Vaara, T. Vaara, Antimicrobiology agents Chemotherapeutant, 1983, 24, 114; H. Nikaido, Escherichia coli and Salmonella: Cellular and Molecular Biology, American Society for Microbiology, Washington, D.C., 1996, 1, 29; S. H. Lim, S. M. Hudsen, Carbohydrate Research, 2004, 339, 313; X. Wang, Y. Du, H. Liu, Carbohydrate Polymers, 2004, 56, 21; L. Y. Zheng, J. F. Zhu, K. S. Sun, Materials Science and Engineering, 2000, 18, 22; H. Liu, Y. Du, J. Yang, H. Zhu, Carbohydrate Polymers, 2004, 55, 291; X. F. Liu, Y. L. Guan, D. Z. Yang, Z. Li, K. D. Yao, J. Appl. Polymer Sci. 2001, 29, 1324; and L. Y. Zheng, J. F. Zhu, Carbohydrate Polymers, 2003, 54, 527; each of which is incorporated by reference herein in its entirety.

In an embodiment, the chitosan-latex binder can be made by using any suitable methodology. In an embodiment, a method of making a chitosan-latex binder can comprise a step of contacting chitosan with an acidic solution to form a chitosan solution. Generally, chitosan is insoluble in water, but is soluble in mild acids. In some aspects, chitosan can be chemically modified to enhance its water solubility, and it could be dissolved in water to form the chitosan solution, which chitosan solution could be used for contacting with the latex binder to form the chitosan latex binder. In an embodiment, the step of contacting chitosan with an acidic solution to form a chitosan solution can further comprise mixing, agitating, stirring, shaking, and the like, or combinations thereof to facilitate the chitosan solubilizing in the solution. As will be appreciated by one of skill in the art, and with the help of this disclosure, the chitosan can be contacted with the acidic solution under agitation.

In an embodiment, the acidic solution can comprise an acid in an amount of from about 0.1 wt. % to about 5 wt. %, alternatively from about 0.2 wt. % to about 4 wt. %, or alternatively from about 0.25 wt. % to about 2.5 wt. %. Nonlimiting examples of acids suitable for use in the present disclosure for preparing the acidic solution include acetic acid, hydrochloric acid, citric acid, lactic acid, formic acid, adipic acid, malic acid, propionic acid, succinic acid, oxalic acid, thiolic acid, hydrofluoric acid, hydrobromic acid, and the like, or combinations thereof.

In an embodiment, the acidic solution can have a pH of from about 1 to about 5, alternatively from about 1.5 to about 4.5, or alternatively from about 2 to about 4. As will be appreciated by one of skill in the art, and with the help of this disclosure, chitosan precipitates (e.g., comes out of the solution) at pH values above 6-7, unless the chitosan has been specifically modified to enhance its water solubility.

In an embodiment, the chitosan solution can be prepared by combining the chitosan with the acidic solution in any suitable order.

In some embodiments, the chitosan can be added to the acidic solution (e.g., a chitosan powder can be added to an acidic solution). In such embodiments, the solution can be further agitated, for example by magnetic stirring, to facilitate the chitosan solubilizing in the solution.

In other embodiments, the acidic solution can be added to the chitosan (e.g., the acidic solution can be poured onto the chitosan powder). In such embodiments, the solution can be further agitated, for example by magnetic stirring, to facilitate the chitosan solubilizing in the solution.

In yet other embodiments, water can be added to the chitosan, for example water can be poured onto the chitosan, the resulting suspension can be agitated until homogenous, and an acid can be added to the chitosan suspension in water until the chitosan solution achieves a desired pH and/or the chitosan is fully solubilized in the solution.

In an embodiment, the step of contacting chitosan with an acidic solution to form a chitosan solution can further comprise heating to ambient temperatures to facilitate the chitosan solubilizing in the solution. In some embodiments, the chitosan can be contacted with water or an acidic solution pre-heated to a temperature effective to facilitate the chitosan solubilizing in the solution. In embodiments where the solution is heated to facilitate the chitosan solubilizing, the chitosan solution can be further cooled to ambient temperature prior to a step of contacting the chitosan solution with a latex binder.

In an embodiment, the chitosan solution can comprise chitosan in an amount of from about 0.1 wt. % to about 5 wt. %, alternatively from about 0.25 wt. % to about 4 wt. %, or alternatively from about 0.5 wt. % to about 3 wt. %.

In an embodiment, a method of making a chitosan-latex binder can comprise a step of contacting at least a portion of the chitosan solution with a latex binder to form the chitosan-latex binder. In some embodiments, the latex binder can be an emulsion, as previously described herein. In other embodiments, the latex binder can be a powder, as previously described herein. In an embodiment, the step of contacting the chitosan solution with the latex binder to form the chitosan-latex binder can further comprise mixing, agitating, stirring, shaking, and the like, or combinations thereof to facilitate the formation of a stable emulsion. As will be appreciated by one of skill in the art, and with the help of this disclosure, the chitosan solution can be contacted with the latex binder under agitation.

In an embodiment, the chitosan-latex binder can be prepared by combining the chitosan solution with the latex binder in any suitable order.

In some embodiments, the chitosan solution can be added to the latex binder (e.g., the chitosan solution can be poured into the latex binder emulsion, or onto the latex powder), for example under agitation, such as by magnetic stirring, to facilitate the formation of a stable emulsion. The resulting mixture can be further agitated, for example by magnetic stirring, to facilitate the formation of a stable emulsion.

In other embodiments, the latex binder can be added to the chitosan solution (e.g., the latex binder emulsion can be poured onto the chitosan solution, the latex powder can be added to the chitosan solution), for example under agitation, such as by magnetic stirring, to facilitate the formation of a stable emulsion. In such embodiments, the resulting mixture can be further agitated, once all of the necessary latex binder was added to the chitosan solution, to produce the chitosan-latex binder.

In an embodiment, the chitosan-latex binder as described herein can be used in a process for producing nonwovens. As used herein, a “nonwoven,” a “nonwoven material,” or a “nonwoven fabric” refers to a sheet of fibers, continuous filaments, or chopped yarns of any nature or origin, that have been formed into a web by any means, and bonded together by at least the chitosan-latex binder described herein, wherein weaving or knitting is not involved in forming and/or bonding the web. Further, for purposes of the disclosure herein, a “nonwoven,” a “nonwoven material,” or a “nonwoven fabric” refers to sheet or web structures made of fiber, filaments, molten plastic, or plastic films bonded together at least chemically (e.g., bonding with a cementing medium or binder, such as the chitosan-latex binder as described herein), although other types of bonding can be used for producing nonwovens, such as thermal bonding (e.g., fusing of the fibers, as in the case of thermoplastic fibers), mechanical bonding (e.g., mechanical interlocking of fibers in a random web or mat), etc. Web bonding processes impart integrity to the web and the resulting material is often referred to as fabric(s). Often, the fabrics can undergo further mechanical and/or chemical finishing or both in order to achieve enhanced properties and appearance. As will be appreciated by one of skill in the art, and with the help of this disclosure, all these processes along with the choice of fibers determine the structures and properties of the nonwoven fabrics.

A variety of processes can be used to assemble the nonwoven fabrics described herein, including but not limited to, traditional wet laying processes and dry forming processes such as air-laying and carding, or any other suitable forming technologies such as spunlace or airlaid. In an embodiment, the nonwoven fabrics can be prepared by an airlaid processes. Processes and equipment suitable for the production of nonwoven materials are described in more detail U.S. Pat. Nos. 4,335,066; 4,732,552; 4,375,448; 4,366,111; 4,375,447; 4,640,810; 206,632; 2,543,870; 2,588,533; 5,234,550; 4,351,793; 4,264,289; 4,666,390; 4,582,666; 5,076,774; 874,418; 5,566,611; 6,284,145; 6,363,580; and 6,726,461; each of which is incorporated by reference herein in its entirety.

In an embodiment, the nonwovens as described herein can be made by using any suitable methodology. In an embodiment, a method of making a nonwoven fabric can comprise a step of forming a plurality of fibers into a fiber web. Generally, a web forming process is a process that disperses the fibers or filaments to form a sheet or web and can also stack the webs to form multi-layered webs, which are sometimes referred to as batts.

In some embodiments, the step of forming a plurality of fibers into a fiber web can be a wet laid process. In other embodiments, the step of forming a plurality of fibers into a fiber web can be a dry laid process.

Generally, techniques for wet laying fibrous material to form sheets, such as dry lap and paper, are well known in the art. Suitable wet laying techniques include, but are not limited to, hand sheeting and wet laying with paper making machines as described in U.S. Pat. No. 3,301,746, which is incorporated by reference herein in its entirety. The principle of wet laying is similar to paper manufacturing. The difference lies in the amount of synthetic fibers present in a wet laid nonwoven material. A dilute slurry of water and fibers can be deposited on a moving wire screen and drained to form a web. The web can be further dewatered, consolidated, by pressing between rollers, and dried. Impregnation with binders (e.g., chitosan-latex binder) can follow the web forming process. The strength of a randomly oriented web is rather similar in all directions in the plane of the fabric for wet laid nonwovens.

The dry laid process can include a mechanical process known as carding, which is described in more detail in U.S. Pat. No. 797,749, which is incorporated by reference herein in its entirety. The carding process can include an airstream component to randomize the orientation of fibers when they are collected on a forming wire. Typically, the fiber length for a mechanically carded process can be in the range of 38-60 mm. Longer fiber lengths can be possible depending on the set up of the card. Some mechanical cards, such as the Truzschler-Fliessner EWK-413 card, can run fibers having significantly shorter length than 38 mm.

In an embodiment, the dry laid process can comprise an air-laid process (e.g., air-forming process). The air-laid process employs only air flow, gravity, and centripetal force to deposit a stream of fibers onto a moving forming wire that conveys the fiber web to a web bonding process (e.g., chemical bonding with a chitosan-latex binder). The air-laid process is effective at forming a uniform web of short fibers, e.g., typically less than 6 mm long, with low fiber to fiber cohesion and low potential for generating static. The dominant fiber utilized in these air driven processes is wood pulp, which can be processed at high throughput owing to its short length of 3 mm or less. Typically, fiber lengths above 12 mm are commercially impractical for air-laid processes. Pulp-based air-formed nonwoven webs frequently incorporate 10% to 20% of 4 to 6 mm thermoplastic fibers that could melt and additionally bond the air-laid web together when the air-formed web is heated, for example by passing through ovens. It is possible to air-form a layer of 100% thermoplastic fiber, however, the fiber throughput rate typically declines significantly with increasing fiber length. Air-laid processes are described in more detail in U.S. Pat. Nos. 4,014,635 and 4,640,810; each of which is incorporated by reference herein in its entirety.

In an embodiment, the plurality of fibers can comprise natural fibers (e.g., cellulosic or cellulose fibers), synthetic fibers, or both. Any cellulosic fibers known in the art, including cellulose fibers of any natural origin, such as those derived from wood pulp, may be used for forming the web. Nonlimiting examples of cellulosic fibers suitable for use in the present disclosure for forming the web include, but are not limited to, wood cellulose; cotton linter pulp; chemically modified cellulose, such as crosslinked cellulose fibers; highly purified cellulose fiber; digested fibers, such as kraft digested fibers, prehydrolyzed kraft digested fibers, soda digested fibers, sulfite digested fibers; chemi-thermally treated fibers, mechanically treated fibers, thermo-mechanically treated fibers; fibers derived from softwoods, such as pines, firs, and spruces; fibers derived from hardwood, such as eucalyptus; fibers derived from Esparto grass, bagasse, kemp, flax, hemp, kenaf, and other lignaceous and cellulosic fiber sources; and the like; or combinations thereof. Nonlimiting example of cellulosic fibers suitable for use in the present disclosure for forming the web include FOLEY FLUFFS fibers, which are bleached Kraft southern pine fibers available from Georgia Pacific; cellulose pulp fibers, which are a southern softwood fluff pulp available from Georgia Pacific; HPF, which is a highly purified cellulose fiber available from Georgia Pacific; and T 730 hardwood pulp, which is an eucalyptus pulp available from Weyerheuser.

In an embodiment, the plurality of fibers can comprise synthetic fibers. Nonlimiting example of cellulosic fibers suitable for use in the present disclosure for forming the web include acrylic polymers, polyamides (e.g., Nylon 6, Nylon 6/6, Nylon 12, polyaspartic acid, polyglutamic acid, etc.), polyamines, polyimides, polyacrylics (e.g., polyacrylamide, polyacrylonitrile, esters of methacrylic acid and acrylic acid, etc.), polycarbonates (e.g., polybisphenol A carbonate, polypropylene carbonate, etc.), polydienes (e.g., polybutadiene, polyisoprene, polynorbornene, etc.), polyepoxides, polyesters (e.g., polyethylene terephthalate, polybutylene terephthalate, polytrimethylene terephthalate, polycaprolactone, polyglycolide, polylactide, polyhydroxybutyrate, polyhydroxyvalerate, polyethylene adipate, polybutylene adipate, polypropylene succinate, etc.), polyethers (e.g., polyethylene glycol (polyethylene oxide), polybutylene glycol, polypropylene oxide, polyoxymethylene (paraformaldehyde), polytetramethylene ether (polytetrahydrofuran), polyepichlorohydrin, etc.), polyfluorocarbons, formaldehyde polymers (e.g., urea-formaldehyde, melamine-formaldehyde, phenol formaldehyde, etc.), natural polymers (e.g., cellulosics, chitosans, lignins, waxes, etc.), polyolefins (e.g., polyethylene, polypropylene, polybutylene, polybutene, polyoctene, etc.), polyphenylenes (e.g., polyphenylene oxide, polyphenylene sulfide, polyphenylene ether sulfone, etc.), silicon containing polymers (e.g., polydimethyl siloxane, polycarbomethyl silane, etc.), polyurethanes, polyvinyls (e.g., polyvinyl butyral, polyvinyl alcohol, esters and ethers of polyvinyl alcohol, polyvinyl acetate, polystyrene, polymethylstyrene, polyvinyl chloride, polyvinyl pryrrolidone, polymethyl vinyl ether, polyethyl vinyl ether, polyvinyl methyl ketone, etc.), polyacetals, polyarylates, and copolymers (e.g., polyethylene-co-vinyl acetate, polyethylene-co-acrylic acid, polybutylene terephthalate-co-polyethylene terephthalate, polylauryllactam-block-polytetrahydrofuran, etc.), polylactic acid based polymers, derivatives thereof, copolymers thereof, and the like, or combinations thereof.

In some embodiments, the synthetic fibers can comprise multicomponent fibers, for example multicomponent fibers having enhanced reversible thermal properties. Generally, multicomponent fibers contain temperature regulating materials, such as phase change materials having the ability to absorb or release thermal energy to reduce or eliminate heat flow. In general, a phase change material can comprise any substance, or mixture of substances, that has the capability of absorbing or releasing thermal energy to reduce or eliminate heat flow at or within a temperature stabilizing range. The temperature stabilizing range may comprise a particular transition temperature or range of transition temperatures. A phase change material used in nonwoven fabrics as described herein can inhibit a flow of thermal energy during a time when the phase change material is absorbing or releasing heat, typically as the phase change material undergoes a transition between two states, such as, for example, liquid and solid states, liquid and gaseous states, solid and gaseous states, or two solid states. Phase changing is typically transient, and will occur until a latent heat of the phase change material is absorbed or released during a heating or cooling process. Thermal energy may be stored or removed from the phase change material, and the phase change material typically can be effectively recharged by a source of heat or cold. By selecting an appropriate phase change material, the multi-component fiber may be designed for use in any one of numerous products. Multicomponent fibers having enhanced reversible thermal properties are described in more detail in U.S. Pat. No. 6,855,422, which is incorporated by reference herein in its entirety.

In some embodiments, the synthetic fibers can comprise bicomponent fibers. Generally, bicomponent fibers can have a core and a sheath surrounding the core, wherein the core and the sheath comprise different polymers. For example, the core comprises a first polymer, and the sheath comprises a second polymer, wherein the first polymer and the second polymer are different (e.g., the first polymer and the second polymer have different melting temperatures). Bicomponent fibers are typically used for producing nonwoven materials by air-laid techniques.

Bicomponent fibers may incorporate a variety of polymers as their core and sheath components. Bicomponent fibers that have a polyethylene (PE) or modified PE sheath typically have a polyethyleneterephthalate (PET) or polypropylene (PP) core. In an embodiment, the bicomponent fiber can have a core made of polyester and a sheath made of polyethylene.

In an embodiment, bicomponent fibers can have a length of equal to or greater than about 6 mm, alternatively equal to or greater than about 8 mm, alternatively equal to or greater than about 10 mm, alternatively equal to or greater than about 12 mm, alternatively from about 3 mm to about 36 mm, alternatively from about 4 mm to about 24 mm, alternatively from about 5 mm to about 18 mm, or alternatively from about 6 mm to about 12 mm. The bicomponent fibers suitable for use in the present disclosure can have any suitable geometry, such as concentric, eccentric, side by side, islands in a sea, pie segments and other variations.

Various degrees of stretching, drawing or draw ratios can be used for the bicomponent fibers suitable for use in the present disclosure, including partially drawn and highly drawn bicomponent fibers and homopolymers. These fibers can include a variety of polymers and may have a partially drawn core, a partially drawn sheath or a partially drawn core and sheath, or they may be a homopolymer that is partially drawn. In some embodiments, the bicomponent fibers can have a partially drawn core. Highly drawn bicomponent fibers are described in more detail later herein.

The bicomponent fibers suitable for use in the present disclosure can include fibers that utilize a partially drawn polyester core with a variety of sheath materials, specifically including a polyethylene sheath. The use of both partially drawn and highly drawn bicomponent fibers in the same structure can be leveraged to meet specific physical and performance properties based on how the fibers are incorporated into the structure. The degree to which the partially drawn bicomponent fibers are drawn is not limited in scope as different degrees of drawing will yield different enhancements in performance. The scope of the partially drawn bicomponent fibers encompasses fibers with various core sheath configurations including, but not limited to concentric, eccentric, side by side, islands in a sea, pie segments and other variations. In addition, the bicomponent fibers can comprise partially drawn homopolymers such as polyester, polypropylene, nylon, and other melt spinnable polymers. A nonlimiting example of partially drawn core bicomponent fibers suitable for use in the present disclosure include TREVIRA T265 bicomponent fibers, which are partially drawn core with a core made of polybutylene terephthalate (PBT) and a sheath made of polyethylene, and which are available from Trevira, Bobingen, Germany.

As used herein, the term “partially drawn core” or “partially drawn fiber” refers to all or part of a fiber, such as with a bicomponent fiber, that has not been drawn or stretched to achieve the highest possible tenacity or strength in its fiber form, but that some degree of drawing or stretching has been done to induce some degree of orientation or crystallinity and strength into the fiber. As such, a partially drawn core bicomponent fiber or a partially drawn homopolymer can still capable of being stretched or drawn further once incorporated into an article. This allows the partially drawn core bicomponent fiber or partially drawn homopolymer to provide additional strength and elongation to the article as it is further drawn while incorporated within an article. A homopolymer or bicomponent fiber can be typically stretched close to the point of failure as this induces a high level of crystallinity and strength into the fiber form. The drawing or stretching of a filament, before it is cut into fibers, can occur in both the spinning and drawing steps. Drawing during the spinning step, also known as “draw-down,” occurs when the molten fiber is pulled from the face of a spinneret resulting in drawing of the spun filament. Some degree of drawing is required in order to prevent the as-spun filament from becoming embrittled due to aging, which can cause a catastrophic failure, such as breaking, during the drawing step. Spinning and drawing homopolymer and bicomponent fibers are disclosed in more detail in U.S. Pat. Nos. 4,115,989; 4,217,321; 4,529,368; 4,687,610; 5,185,199; 5,372,885; and 6,841,245; each of which is incorporated by reference herein in its entirety. Some fibers, yarns and other melt spun or extruded materials can be referred to as undrawn, but still have some drawing during the melt spinning phase where the polymer is pulled away from the face of the spinneret. Some other fibers, yarns and other melt spun or extruded materials where no tension is applied to the fibers as they leave the face of the spinneret, for example adhesive polymers, can also be referred to as undrawn. Undrawn polymeric fibers suitable for use in the present disclosure are disclosed in more detail in U.S. Pat. Nos. 3,931,386, 4,021,410, 4,237,187, 4,434,204, 4,609,710, 5,229,060, 5,336,709, 5,634,249, 5,660,804, 5,773,825, 5,811,186, 5,849,232, 5,972,463, and 6,080,482, each of which is incorporated by reference herein in its entirety.

In an embodiment, the bicomponent fibers can comprise highly drawn bicomponent fibers. As used herein, “highly drawn” is defined as being drawn or stretched close to the maximum level of drawing or stretching such that it will induce a high degree of molecular orientation in the fiber, and enhanced strength in the fiber form, without overdrawing or over-stretching such that the fiber has a catastrophic failure and potentially breaks. In an embodiment, the bicomponent fibers can comprise bicomponent fibers that are partially drawn with varying degrees of draw or stretch; highly drawn bicomponent fibers; and mixtures thereof. Nonlimiting examples of highly drawn bicomponent fibers suitable for use in the present disclosure include INVISTA T255 bicomponent fibers and TREVIRA T255 bicomponent fibers, which are highly drawn polyester core bicomponent fibers with a variety of sheath materials, specifically including a polyethylene sheath, and which are available from Invista, Salisbury, N.C., and Trevira, Bobingen, Germany, respectively; and AL-Adhesion-C bicomponent fibers, which are highly drawn polypropylene core bicomponent fiber with a variety of sheath materials, specifically including a polyethylene sheath, which are available from ES FiberVisions, Varde, Denmark.

Bicomponent fibers suitable for use in the present disclosure are described in more detail in U.S. Pat. Nos. 5,372,885 and 5,456,982, each of which is incorporated by reference herein in its entirety.

Bicomponent fibers can be typically fabricated commercially by melt spinning, wherein each molten polymer is extruded through a die, e.g., a spinneret, with subsequent pulling of the molten polymer to move it away from the face of the spinneret, solidification of the polymer by heat transfer to a surrounding fluid medium, for example chilled air, and taking up of the now solid filament.

As used herein, the term “melt spinning” refers to a process where molten polymer is extruded through a spinneret or die into a filament that may subsequently be converted into individual fibers via cutting. Melt spinning can utilize polymers that originate via a continuously fed process or via chip form where the chip is heated to a molten state. In both cases, the molten polymer or polymers are pumped at a specified flow rate through a spinneret. A spinneret is plate with holes, usually made of metal or ceramics, with the number of holes and hole sizes varying depending on the type of fiber desired. The spinneret may also contain a filtration media that can act as both a filter and a static mixer to give a more uniform product. After the molten polymer or polymers are pumped through the spinneret it forms a filament that is quenched or cooled almost immediately with a medium that will efficiently remove the heat from the molten polymer or polymers. This can allow the filaments to maintain their shape as a filament for future steps in the fiber forming process. As used herein, the term “filament” refers to a continuous structure such as the form that a fiber initially has during the spinning, drawing, crimping and other steps of the manufacturing process prior to the cutting step. The continuous filaments that are pulled from the face of the spinneret and are brought together to form a tow, which is essentially a bundle of filaments. The process by which the filaments are taken away from the face of the spinneret, which is essentially pulling, results in a slight orientation within the polymer as this pulling results in some drawing of the fiber. The tow, also referred to as a spun yarn, is then ready for subsequent steps in the fiber forming process, including, but not limited to drawing. Additional steps after melt spinning may also include hot or cold drawing, heat treating, crimping and cutting.

As used herein, the term “drawing” refers to a process where the filament or filaments from the melt spinning step, which may be referred to as a tow or spun yarn, are mechanically pulled, stretched or drawn. This results in a decreased diameter for the individual filaments in the tow while also increasing molecular orientation and increasing tensile strength. Heat is generally applied to assist in the drawing of the tow. Drawing may be accomplished by passing the tow over rolls of increasing speeds that will pull the individual filaments of the tow and cause their diameter to decrease, helping to align individual polymer chains within the filament, also stated as giving the molecular orientation that results in enhanced tensile strength. Subsequent steps may also include heat setting, crimping, cutting and baling.

This overall manufacturing process for the bicomponent fibers is generally carried out as a discontinuous two-step process that first involves spinning of the filaments and their collection into a tow that comprises numerous filaments. During the spinning step, when molten polymer is pulled away from the face of the spinneret, some drawing of the filament does occur which may also be called the draw-down. This is followed by a second step where the spun fibers are drawn or stretched to increase molecular alignment and crystallinity and to give enhanced strength and other physical properties to the individual filaments. Subsequent steps may include heat setting, crimping and cutting of the filament into fibers. The drawing or stretching step may involve drawing the core of the bicomponent fiber, the sheath of the bicomponent fiber, or both the core and the sheath of the bicomponent fiber depending on the materials from which the core and sheath are comprised, as well as the conditions employed during the drawing or stretching process. Bicomponent fibers may also be formed in a continuous process where the spinning and drawing are done in a continuous process. Bicomponent fibers and filaments are described in more detail in Encyclopedia of Polymer Science and Technology, Interscience, New York, vol. 6 (1967), pp. 505-555 and vol. 9 (1968), pp. 403-440; Kirk-Othmer Encyclopedia of Chemical Technology, vol. 16 for “Olefin Fibers”, John Wiley and Sons, New York, 1981, 3rd edition; Man Made and Fiber and Textile Dictionary, Celanese Corporation; Fundamentals of Fibre Formation—The Science of Fibre Spinning and Drawing, Adrezij Ziabicki, John Wiley and Sons, London/New York, 1976; and Man Made Fibres, by R. W. Moncrieff, John Wiley and Sons, London/New York, 1975; each of which is incorporated by reference herein in its entirety. Processes for producing bicomponent fibers are described in more detail in U.S. Pat. Nos. 4,950,541, 5,082,899, 5,126,199, 5,372,885, 5,456,982, 5,705,565, 2,861,319, 2,931,091, 2,989,798, 3,038,235, 3,081,490, 3,117,362, 3,121,254, 3,188,689, 3,237,245, 3,249,669, 3,457,342, 3,466,703, 3,469,279, 3,500,498, 3,585,685, 3,163,170, 3,692,423, 3,716,317, 3,778,208, 3,787,162, 3,814,561, 3,963,406, 3,992,499, 4,052,146, 4,251,200, 4,350,006, 4,370,114, 4,406,850, 4,445,833, 4,717,325, 4,743,189, 5,162,074, 5,256,050, 5,505,889, 5,582,913, and 6,670,035, each of which is incorporated by reference herein in its entirety.

In an embodiment, a method of making a nonwoven fabric can comprise a step of contacting at least a portion of the fiber web with the chitosan-latex binder to form a binder impregnated fiber web. The fiber web can be contacted with the chitosan-latex binder by using any suitable methodology. In an embodiment, the chitosan-latex binder can be contacted with (e.g., applied to) the fiber web via a saturation bonding method, a foam bonding method, a spray bonding method, a print bonding method, or combinations thereof.

In an embodiment, the chitosan-latex binder can be used on one or both of the outer surfaces of the fiber to control dusting, as will be discussed in more detail later herein, in addition to strengthening the fiber web. In embodiments where it is desirable that the chitosan-latex binder be applied only on the outer surface of the substrate, the chitosan-latex binder emulsion can be lightly sprayed, printed, foamed, or rolled onto the fiber web.

In an embodiment, the step of contacting the fiber web with the chitosan-latex binder can comprise a saturation bonding process. Saturation chemical bonding involves complete immersion of a nonwoven web (e.g., fiber web) in a bath containing a binder (e.g., chitosan-latex binder), followed by the excess binder being removed by a pair of nip rolls (e.g., pinch rolls). The fiber web is guided through the saturation bath by rollers and then presses between a pair of nip rolls to squeeze out excess liquid (e.g., chitosan-latex binder emulsion). The amount of chitosan-latex binder taken up by the nonwoven depends on a variety of factors such as the basis weight of the nonwoven, length of time spent in the bath, wettability of the fibers and nip pressure. The saturation bonding process can provide relatively high binder to fiber levels uniformly throughout the nonwoven. However, the saturation bonding process includes short wetting time, and as such is more suitable for lightweight and highly permeable nonwovens.

In an embodiment, the step of contacting the fiber web with the chitosan-latex binder can comprise a foam bonding process, wherein air or water is used to dilute the chitosan-latex binder and as a mean to carry the binder to the fibers. Diluting the binder with air rather than with water has the advantage that drying is faster and energy cost is reduced remarkably. Binder foam can be generated mechanically and can be stabilized with a stabilizing agent to prevent collapse during application to the fiber web. Foam can be applied so as to remain at the surface of the fiber web or can be made to penetrate all the way through a fiber web cross-section. At least one reciprocating foam spreader is commonly used to distribute the foam across the width of the web/fabric. The excess foam can be removed through the porous portion of the web (e.g., space between fibers), for example via a vacuum extractor located on a side of the fiber web that is opposite to the side of the web where the foam is applied. Generally, foam bonding has more efficiency drying and the ability to control fabric softness. However, adequate foaming and uniform binder distribution can be difficult to achieve.

In an embodiment, the step of contacting the fiber web with the chitosan-latex binder can comprise a print bonding process. Generally, for print bonding, the fiber web must be dry. The print bonding process applies the chitosan-latex binder only in predetermined areas as dictated by the pattern of the printing surfaces. The chitosan-latex binder can be transferred to the fiber web via a feed roll and an engraved roll. As the fiber web passes the engraved roll, it is pressed against the surface by a rubber roll, thereby transferring the chitosan-latex binder to the fabric in the predetermined areas. The excess of chitosan-latex binder can be removed by a doctor blade. The print bonding process is suitable for applying low levels of binder to the surface of the fiber web.

In an embodiment, the step of contacting the fiber web with the chitosan-latex binder can comprise a spray bonding process, wherein the chitosan-latex binder can be sprayed onto the fiber web. The chitosan-latex binder can be sprayed onto a moving fiber web in fine droplet form through a system of nozzles. The spray bonding process can be used to make highly porous and bulky products, where the fiber web does not need to pass between nip rollers. Spraying the binder can provide an opportunity for the chitosan-latex binder emulsion to penetrate fibers material beneath the immediate surface of the fiber web being sprayed. The liquid binder (e.g., chitosan-latex binder emulsion) can be atomized by air pressure, hydraulic pressure, and/or centrifugal force and is generally applied to an upper surface of the fiber web. The depth of penetration of the binder into the substrate depends on a variety of factors such as the wettability of the fibers, permeability of the web, and amount of binder. The spray bonding process can allow for the nonwoven to not be compressed, thereby allowing the nonwoven to substantially retain original bulk and structure. In some embodiments, the chitosan-latex binder can be sprayed onto a dry fiber web. In other embodiments, the chitosan-latex binder can be sprayed onto a wet fiber web, such as a pre-wetted web.

In an embodiment, the fiber web and the chitosan-latex binder can be contacted at a fabric to liquor ratio of from about 1:0.01 to about 1:10, alternatively from about 1:0.02 to about 1:8, or alternatively from about 1:0.05 to about 1:5, wherein the fabric to liquor ratio is a mass to volume ratio expressed in kg fiber web to liters of chitosan-latex binder. For example, a fabric to liquor ratio of 1:0.01 refers to a ratio of 1 kg of fiber web to 0.01 liters of chitosan-latex binder; a fabric to liquor ratio of 1:10 refers to a ratio of 1 kg of fiber web to 10 liters of chitosan-latex binder; etc. For purposes of the disclosure herein the term “liquor” refers to the chitosan-latex binder emulsion.

In an embodiment, a method of making a nonwoven fabric can comprise a step of curing the binder impregnated fiber web to form the nonwoven fabric, wherein the nonwoven fabric comprises a cured chitosan-latex binder, and wherein the cured chitosan-latex binder comprises at least a portion of the chitosan of the chitosan-latex binder and at least a portion of the latex binder of the chitosan-latex binder.

As used herein, “curing,” “cured” and similar terms are intended to encompass the structural and/or morphological change which occurs in a binder composition (e.g., aqueous binder composition) of the present disclosure, such as by covalent chemical reaction (crosslinking), ionic interaction or clustering, improved adhesion to the fiber web substrate, phase transformation or inversion, and hydrogen bonding when the binder composition is dried and heated to cure the binder. As used herein, the term “cured binder” refers to the cured product of the chitosan-latex binder, which cured product bonds the fibers of a fibrous product (e.g., fiber web) together. Generally, the bonding occurs at an intersection of overlapping fibers.

In an embodiment, the step of curing the binder impregnated fiber web to form the nonwoven fabric can comprise drying the binder impregnated fiber web, for example by heating the binder impregnated fiber web to a temperature of from about 120° C. to about 225° C., alternatively from about 125° C. to about 210° C., or alternatively from about 130° C. to about 200° C. The binder impregnated fiber web can be heated by any suitable methodology.

After the binder is applied, the binder impregnated fiber web can be dried, for example in any suitable dryer or oven, to evaporate the binder carrier (e.g., water) and allow the binder (e.g., chitosan and latex) to bond the nonwovens. Crosslinking (if crosslinking groups are present in the binder formulation) can be usually carried out in the same dryer. Nonlimiting examples of dryers suitable for use in the present disclosure include drum dryers, heated drums, steam-heated drying cans, flat belt dryers, stenter-based dryers, thru-air ovens, perforated-drum dryers, infrared dryers, and the like, or combinations thereof. In drum drying or belt drying, the fiber web can be guided over a perforated conveyor surface through which hot air passes, for example air heated to a temperature of from about 120° C. to about 225° C. Air can then be withdrawn from the inside of the drum or through the perforations of the belt and can be reused. Stenter dryers can provide hot air flow to both surfaces of the binder impregnated fiber web. In infrared dryers, water from the binder absorbs infrared energy and it evaporates.

In an embodiment, the step of curing the binder impregnated fiber web to form the nonwoven fabric can comprise thermal bonding. As used herein, “thermal bonding: refers to a technique for bonding a web of fibers in which a heat and/or ultrasonic treatment, with or without pressure, is used to activate a heat-sensitive material. The heat-sensitive material can be in the form of fibers, bicomponent fibers, fusable powders, as part of the web, etc. The bonding may be applied all over (e.g., through bonding or area bonding) or restricted to predetermined, discrete sites (e.g., point bonding). Nonlimiting examples of thermal bonding suitable for use in the present disclosure include calendering, through-air thermal bonding, radiant heat bonding, sonic bonding, and the like, or combinations thereof. Calendering uses heat and high pressure applied through rollers to weld the fiber webs together. Through-air thermal bonding makes bulkier products by the overall bonding of a fiber web containing low melting point fibers, wherein the melting of the fibers takes place in a carefully temperature controlled hot air stream. Drum and blanket systems apply pressure and heat to make products of average bulk. Radiant heat bonding can be achieved by exposing the fiber web to a source of radiant energy in the infrared range, which increases the temperature of the web. Sonic bonding takes place when the molecules of the fibers held under a patterned roller are excited by high frequency energy which produces internal heating.

In an embodiment, the fibers of the nonwoven material can be held together by the chitosan-latex binder; or by the chitosan-latex binder and melted or partially melted synthetic fibers, such as bicomponent fibers. In some embodiments, the fiber web can comprise bicomponent fibers, wherein the bicomponent fibers comprise a core and a sheath surrounding the core. In such embodiment, during thermal bonding of the binder impregnated fiber web at least a portion of the sheath can melt during the thermal bonding and can provide for further bonding of the fiber web.

In an embodiment, a nonwoven fabric can comprise a fiber web as described herein and a cured chitosan-latex binder as described herein. The fiber web can be present in the nonwoven fabric in an amount of from about 85 wt. % to about 99.9 wt. %, alternatively from about 87 wt. % to about 99.5 wt. %, or alternatively from about 90 wt. % to about 99 wt. %, based on the total weight of the nonwoven fabric. The cured chitosan-latex binder can be present in the nonwoven fabric in an amount of from about 0.1 wt. % to about 15 wt. %, alternatively from about 0.5 wt. % to about 13 wt. %, or alternatively from about 1 wt. % to about 10 wt. %, based on the total weight of the nonwoven fabric. The nonwoven fabric can comprise cellulosic fibers and/or synthetic fibers in any suitable amount to confer the desired properties to the nonwoven fabric.

In an embodiment, the fiber web can comprise cellulosic fibers in an amount of from about 50 wt. % to about 90 wt. %, alternatively from about 60 wt. % to 85 wt. %, or alternatively from about 70 wt. % to 80 wt. %, based on the total weight of the fiber web; and synthetic fibers (e.g., bicomponent fibers) in an amount of from about 5 wt. % to about 45 wt. %, alternatively from about 10 wt. % to 35 wt. %, or alternatively from about 15 wt. % to 25 wt. %, based on the total weight of the fiber web. In such embodiment, the synthetic fibers can have a partially drawn core.

In an embodiment, the fiber web can comprise cellulosic fibers in an amount of from about 50 wt. % to about 90 wt. %, alternatively from about 60 wt. % to 85 wt. %, or alternatively from about 70 wt. % to 80 wt. %, based on the total weight of the fiber web; and synthetic fibers (e.g., bicomponent fibers) in an amount of from about 10 wt. % to about 50 wt. %, alternatively from about 15 wt. % to 40 wt. %, or alternatively from about 20 wt. % to 30 wt. %, based on the total weight of the fiber web. In such embodiment, the synthetic fibers can have a partially drawn core.

In an embodiment, the nonwoven fabric as described herein can include any suitable additive, as dictated by the intended use of the nonwoven fabric. Nonlimiting examples of additives suitable for use in the present disclosure include antimicrobial agents, dyes, opacity enhancers, delustrants, brighteners, skin-care additives, odor control agents, detackifying agents, particulates, preservatives, wetting agents, cleaning agents, detergents, surfactants, silicones, emollients, lubricants, fragrance, fragrance solubilizers, fluorescent whitening agents, UV absorbers, pharmaceuticals, pH control agents, and the like, or combinations thereof.

In an embodiment, the nonwoven fabric described herein can comprise the cured chitosan-latex binder in an amount of from about 0.1 g/m² to about 12 g/m², alternatively from about 1 g/m² to about 10 g/m², alternatively from about 2 g/m² to about 8 g/m², based on the surface area of the nonwoven fabric.

In an embodiment, the nonwoven fabric comprising the cured chitosan-latex binder as described herein can be characterized by enhanced tensile properties, when compared to an otherwise similar nonwoven fabric that has been treated with the same latex binder without the chitosan. As will be appreciated by one of skill in the art, and with the help of this disclosure, the tensile properties of the nonwoven fabric depend upon a variety of factors, such as the type of fibers in the web, the method used for forming the web, the type of binder used, the methods used for applying the binder to the web, curing method for the binder, curing time for the binder, etc. Generally, the integrity of the nonwoven fabric can be assessed by tensile testing, for example by dry tensile strength measured in the machine direction, wet tensile strength measured in the cross direction, and the like, or combinations thereof. Typically, the tensile strength for nonwoven fabrics is measured in cross direction wet strength and machine direction dry strength, but can also be measured in cross direction dry strength and machine direction wet strength.

In an embodiment, the nonwoven fabric as described herein can be characterized by a dry tensile strength measured in the machine direction of equal to or greater than about 400 grams per linear inch (gli), alternatively equal to or greater than about 800 gli, or alternatively equal to or greater than about 1,000 gli, as determined in accordance with EDANA 20.2-89.

In an embodiment, the nonwoven fabric as described herein can be characterized by a dry tensile strength measured in the machine direction which can be increased by equal to or greater than about 50%, alternatively equal to or greater than about 55%, or alternatively equal to or greater than about 60% when compared to a dry tensile strength measured in the machine direction of an otherwise similar nonwoven fabric that has been treated with the same latex binder without the chitosan, wherein the tensile strength is determined in accordance with EDANA 20.2-89.

In an embodiment, a nonwoven fabric treated with 2.5 wt. % chitosan-latex binder can be characterized by a dry tensile strength that can be increased by equal to or greater than about 40%, alternatively equal to or greater than about 45%, or alternatively equal to or greater than about 50% when compared to a tensile strength of an otherwise similar nonwoven fabric that has been treated with 5 wt. % of the same latex binder without the chitosan, wherein the tensile strength is determined in accordance with EDANA 20.2-89.

In an embodiment, the nonwoven fabric as described herein can be characterized by a wet tensile strength measured in the cross direction of equal to or greater than about 400 gli, alternatively equal to or greater than about 600 gli, or alternatively equal to or greater than about 800 gli, as determined in accordance with EDANA 20.2-89.

In an embodiment, the nonwoven fabric as described herein can be characterized by a wet tensile strength measured in the cross direction which can be increased by equal to or greater than about 105%, alternatively equal to or greater than about 110%, or alternatively equal to or greater than about 125% when compared to a wet tensile strength measured in the cross direction of an otherwise similar nonwoven fabric that has been treated with the same latex binder without the chitosan, wherein the tensile strength is determined in accordance with EDANA 20.2-89.

In some embodiments, nonwovens may be used as a component of a wide variety of absorbent structures, such as surgical drapes and associated materials, diapers, feminine hygiene materials, wipes, mops, and the like. In such embodiments, it may be desirable for the nonwovens to have an enhanced water absorbency.

In an embodiment, the nonwoven fabric as described herein can be characterized by a water absorbency of equal to or greater than about 1.2 grams of water per gram of nonwoven fabric (g/gm), alternatively equal to or greater than about 2.5 g/gm, or alternatively equal to or greater than about 5 g/gm, as determined in accordance with EDANA 10.3-99.

In an embodiment, the nonwoven fabric as described herein can be characterized by a water absorbency which can be increased by equal to or greater than about 10%, alternatively equal to or greater than about 20%, or alternatively equal to or greater than about 25% when compared to a water absorbency of an otherwise similar nonwoven fabric that has been treated with the same latex binder without the chitosan, wherein the water absorbency is determined in accordance with EDANA 10.3-99.

In an embodiment, the nonwoven fabric treated with 2.5 wt. % chitosan-latex binder can be characterized by a water absorbency that is increased by equal to or greater than about 25%, alternatively equal to or greater than about 30%, or alternatively equal to or greater than about 35% when compared to a water absorbency of an otherwise similar nonwoven fabric that has been treated with 5 wt. % of the same latex binder without the chitosan, wherein the water absorbency is determined in accordance with EDANA 10.3-99.

For purposes of the disclosure herein, the term “caliper” refers to the thickness of the nonwoven material. The caliper generally refers to the distance between an upper surface and a lower surface of a material, wherein the caliper can be measured under a specified pressure.

In an embodiment, the nonwoven fabric as described herein can be characterized by a caliper of equal to or greater than about 0.1 mm, alternatively equal to or greater than about 0.5 mm, alternatively equal to or greater than about 1 mm, alternatively from about 0.1 mm to about 18 mm, alternatively from about 0.1 mm to about 15 mm, alternatively from about 0.1 mm to about 10 mm, alternatively from about 0.5 mm to about 4 mm, or alternatively from about 0.5 mm to about 2.5 mm, as determined in accordance with EDANA 30.5-99.

In an embodiment, the nonwoven fabric as described herein can be characterized by a caliper which can be increased by equal to or greater than about 10%, alternatively equal to or greater than about 15%, or alternatively equal to or greater than about 20% when compared to a caliper of an otherwise similar nonwoven fabric that has been treated with the same latex binder without the chitosan, wherein the caliper is determined in accordance with EDANA 30.5-99.

In an embodiment, the nonwoven fabric treated with 2.5 wt. % chitosan-latex binder can be characterized by a caliper that can be increased by equal to or greater than about 15%, alternatively equal to or greater than about 20%, or alternatively equal to or greater than about 25% when compared to a caliper of an otherwise similar nonwoven fabric that has been treated with 5 wt. % of the same latex binder without the chitosan.

Generally, nonwoven materials can exhibit relatively high dust levels, which is typically difficult to control with conventional latex binder compositions. Elevated dust levels can be a health concern, as well as an environmental concern.

In an embodiment, the nonwoven fabric as described herein can be characterized by a dust level of less than about 5 wt. %, alternatively less than about 4 wt. %, or alternatively less than about 3 wt. %, based on the total weight of the nonwoven fabric.

In an embodiment, the nonwoven fabric as described herein can be characterized by a dust level which can be decreased by equal to or greater than about 45%, alternatively equal to or greater than about 50%, or alternatively equal to or greater than about 60% when compared to a dust level of an otherwise similar nonwoven fabric that has been treated with the same latex binder without the chitosan.

In an embodiment, the nonwoven fabric treated with 2.5 wt. % chitosan-latex binder can be characterized by a dust level that is decreased by equal to or greater than about 30%, alternatively equal to or greater than about 40%, or alternatively equal to or greater than about 50% when compared to a dust level of an otherwise similar nonwoven fabric that has been treated with 5 wt. % of the same latex binder without the chitosan.

In an embodiment, the nonwoven fabric comprising the cured chitosan-latex binder as described herein can be formed into any suitable article of manufacture by using any suitable methodology. Nonlimiting examples of articles that can be formed from the nonwoven fabrics of the present disclosure include wipes, tissues, towels, medical drapes, bandages, caps, face masks, surgical scrubs, medical gowns, filters, diapers, padding, packaging, insulation, carpeting, upholstery, fabric dryer sheets, disposable textiles, earphone protection covers, insulation, wall coverings, and the like, or combinations thereof.

In an embodiment, a chitosan-latex binder can comprise chitosan and latex binder in a weight ratio of chitosan to latex binder of from about 1:500 to about 1:10,000; wherein the chitosan-latex binder comprises the chitosan in an amount of from about 0.1 wt. % to about 0.5 wt. %; wherein the chitosan-latex binder comprises the latex binder in an amount of from about 99.5 wt. % to about 99.9 wt. %; and wherein the chitosan-latex binder is a sprayable emulsion having a pH of from about 3 to about 5.5. In such embodiment, the latex binder can be vinyl acetate ethylene (VAE) latex binder.

In an embodiment, a method of making a chitosan-latex binder can comprise the steps of (a) contacting chitosan with an acidic solution to form a chitosan solution, wherein the acidic solution comprises acetic acid in an amount of from about 0.5 wt. % to about 3 wt. %, and wherein the chitosan solution comprises chitosan in an amount of from about 0.5 wt. % to about 1.5 wt. %; and (b) contacting at least a portion of the chitosan solution with a latex binder to form the chitosan-latex binder, wherein the chitosan-latex binder is characterized by a chitosan to latex binder weight ratio of from about 1:500 to about 1:10,000. In such embodiment, the latex binder can be vinyl acetate ethylene (VAE) latex binder.

In an embodiment, a method of making a nonwoven fabric can comprise the steps of (a) forming a plurality of fibers into a fiber web via an air-laid process, wherein the plurality of fibers comprises cellulosic fibers in an amount of from about 75 wt. % to about 85 wt. % and bicomponent fibers in an amount of from about 10 wt. % to about 20 wt. %, based on a total weight of the fiber web; (b) spraying at least a portion of the fiber web with a chitosan-latex binder to form a binder impregnated fiber web, wherein the chitosan-latex binder comprises chitosan and latex binder in a weight ratio of chitosan to latex binder of from about 1:500 to about 1:10,000, and wherein the chitosan-latex binder is a sprayable emulsion; and (c) curing the binder impregnated fiber web at temperature of from about 120° C. to about 225° C. to form the nonwoven fabric, wherein the nonwoven fabric comprises a cured chitosan-latex binder, and wherein the cured chitosan-latex binder comprises at least a portion of the chitosan of the chitosan-latex binder and at least a portion of the latex binder of the chitosan-latex binder.

In an embodiment, a nonwoven fabric can comprise a nonwoven fibrous material chemically bound with a latex binder modified with chitosan, wherein the nonwoven fibrous material can comprise a fiber web as described herein and a cured chitosan-latex binder as described herein. The fiber web can be present in the nonwoven fabric in an amount of from about 85 wt. % to about 99.9 wt. %, and the cured chitosan-latex binder can be present in the nonwoven fabric in an amount of from about 0.1 wt. % to about 15 wt. %, based on the total weight of the nonwoven fabric. In such embodiment, the cured chitosan-latex binder can comprise chitosan in an amount of from about 0.01 wt. % to about 1.0 wt. %, and a latex binder in an amount of from about 99.0 wt. % to about 99.99 wt. %.

In an embodiment, a nonwoven fabric as described herein can comprise a fiber web in an amount of from about 85 wt. % to about 99.9 wt. %, based on the total weight of the nonwoven fabric; and a cured chitosan-latex binder in an amount of from about 0.1 wt. % to about 15 wt. %, based on the total weight of the nonwoven fabric, wherein the cured chitosan-latex binder comprises chitosan and latex binder in a weight ratio of chitosan to latex binder of from about 1:10 to about 1:15,000. In such embodiment, the nonwoven fabric can be characterized by a dry tensile strength that is increased by equal to or greater than about 40%, a dust level that is decreased by equal to or greater than about 30%, a caliper that is increased by equal to or greater than about 15%, and a water absorbency that is increased by equal to or greater than about 25%, when compared to the respective properties of an otherwise similar nonwoven fabric that has been treated with the same latex binder without the chitosan; wherein the tensile strength is determined in accordance with EDANA 20.2-89; wherein the caliper is determined in accordance with EDANA 30.5-99; and wherein the water absorbency is determined in accordance with EDANA 10.3-99.

In an embodiment, the chitosan latex binder compositions and methods of making and using same, as well as nonwoven fabrics and methods of making same as disclosed herein can advantageously display improvements in one or more composition characteristics when compared to conventional latex binder compositions and methods of making and using same, as well as conventional nonwoven fabrics and methods of making same, respectively. About a million tons conventional latex binders are often applied into nonwoven fabric annually. In conventional nonwoven fabric manufacturing processes, about 6% to 10% (solid) latex binder is required to achieve the minimum desired properties of nonwoven fabric. Conventional latex binders are fairly expensive (about $ 3,000/MT) and contribute to environmental concerns. In an embodiment, the chitosan-latex binder as disclosed herein can advantageously allow for significantly reducing dust levels as well as increasing absorbency of the nonwoven fabric, resulting in lower amounts of chitosan-latex binder used compared to conventional latex binder, and thus lowering the manufacturing cost of nonwoven fabric.

In an embodiment, the tensile strength properties of the nonwoven fabric as disclosed herein can be advantageously increased by adding chitosan modified latex binder or chitosan blended latex binder (e.g., chitosan-latex binder) to the fiber web to produce the nonwoven fabric.

In an embodiment, the use of very small amounts of chitosan added to latex binder can significantly increase the strength of the nonwoven fabric. As a result, raw material usage can be advantageously reduced by approximately 50% for binder, which can reflect in a major cost reduction of the nonwoven fabric or other applications involving such textiles. The environmental impact can be advantageously quite positive with the reduction in the application of latex binders, as there are emissions directly linked to the volatile by-products of the latex binder, which can be an environmental conceal. Therefore, the chitosan additive can advantageously reduce emissions based upon the direct correlation with a reduced amount of latex binder.

In an embodiment, the chitosan-latex binder can significantly reduce dust levels of nonwoven fabrics, and such improvement can reduce the environmental and health hazard impact of the nonwoven manufacturing process. As will be appreciated by one of skill in the art, and with the help of this disclosure, conventional nonwoven fabrics are generally characterized by high dust levels, which is major conceal in the nonwovens manufacturing.

In an embodiment, the chitosan-latex binder as disclosed herein can advantageously allow for a reduction in bacteria growth, owing to strong antimicrobial properties of the chitosan. As will be a appreciated by one of skill in the art, and with the help of this disclosure, some nonwoven fabrics can be hygienic products with potential for bacterial growth. Additional advantages of the chitosan latex binder compositions and methods of making and using same, as well as nonwoven fabrics and methods of making same as disclosed herein can be apparent to one of skill in the art viewing this disclosure.

### EXAMPLES

The subject matter having been generally described, the following examples are given as particular embodiments of the disclosure and to demonstrate the practice and advantages thereof. It is understood that the examples are given by way of illustration and are not intended to limit the specification of the claims to follow in any manner.

### Example 1

Chitosan-latex binder compositions were prepared and used as follows. Chitosan was dissolved with acidified water (1% acetic acid or 0.6% hydrochloric acid (12N)), wherein the acidified water had a pH of about 1. The dissolved chitosan (e.g., chitosan solution, which had a pH of about 3.5) was blended with vinyl acetate ethylene (VAE) latex binder at varying solid to solids ratios (chitosan to binder, e.g., weight ratios) to optimize the chitosan to binder ratio. After optimizing the chitosan to binder solids ratio (e.g., weight ratio), which was found to be 1:334, the amount of solid (cured chitosan-latex binder) materials on the surface of fabric and blended liquor (chitosan-latex binder emulsion) was also optimized at varying fabric to liquor (chitosan-latex binder emulsion) ratios (1:0.05 to 1:5). The chitosan-latex binder was sprayed on the surface of the fiber web (20% bi-component fiber and 75% pulp fiber, based on the weight of the fiber web) with a spray machine.

Hand sheets (nonwoven fabric) were prepared with a hand sheet molding machine, and the hand sheets were subjected to testing to determine properties such as tensile strength properties, absorbency, caliper, and dust levels. The optimum chitosan to binder solids ratio (e.g., weight ratio), solid (e.g., cured binder) amount, and fabric to liquor ratio were found to be 1/334, 1.5 g/m² and 1:0.05, respectively, based on tensile strength properties, absorbency and low dust levels of nonwoven fabric and economic feasibility.

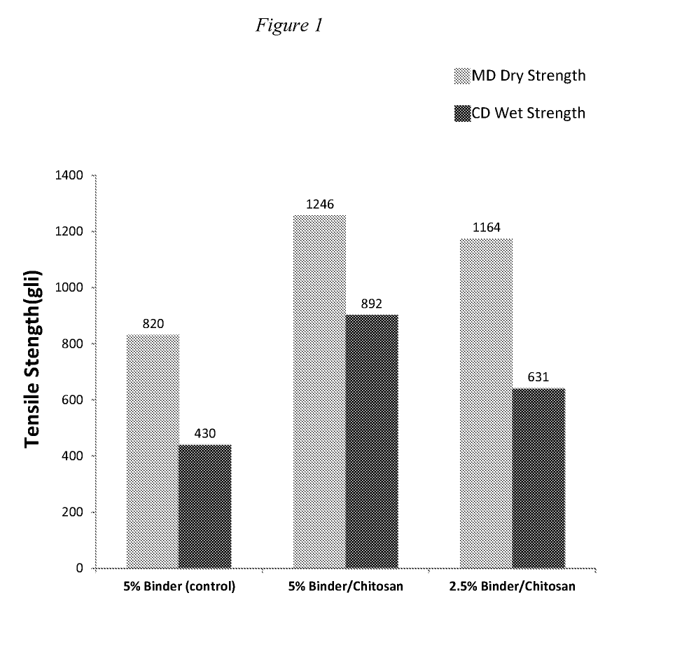

FIGS. 1, 2, and 3 display the hand sheet testing results for tensile strength properties, dust levels, and absorbency and caliper, respectively.

The data in FIG. 1 indicate that the dry tensile strength of nonwoven fabric treated with either 2.5 wt. % or 5 wt. % chitosan-latex binder (chitosan-VAE latex binder) was significantly higher than the dry tensile strength of nonwoven fabric treated with 5 wt. % conventional latex binder (VAE) without the chitosan. The data in FIG. 1 further show that the wet tensile strength of nonwoven fabric treated with either 2.5 wt. % or 5 wt. % chitosan-latex binder (chitosan-VAE latex binder) was significantly higher than the wet tensile strength of nonwoven fabric treated with 5 wt. % conventional latex binder (VAE) without the chitosan. The data in FIG. 1 indicate that small amounts of chitosan can be added to latex binder to significantly increase the strength of the nonwoven fabric. As a result, raw material usage can be reduced by approximately 50% for the latex binder, which can reflect in a major cost reduction for the nonwoven fabric or other applications such textiles. The environmental impact can be quite positive with the reduction in application of latex binder, as there can be emissions directly linked to volatile by-products of binder, which can be a serious environmental concern. Therefore, the chitosan additive can reduce emissions based upon the direct correlation with reduced latex binder use.

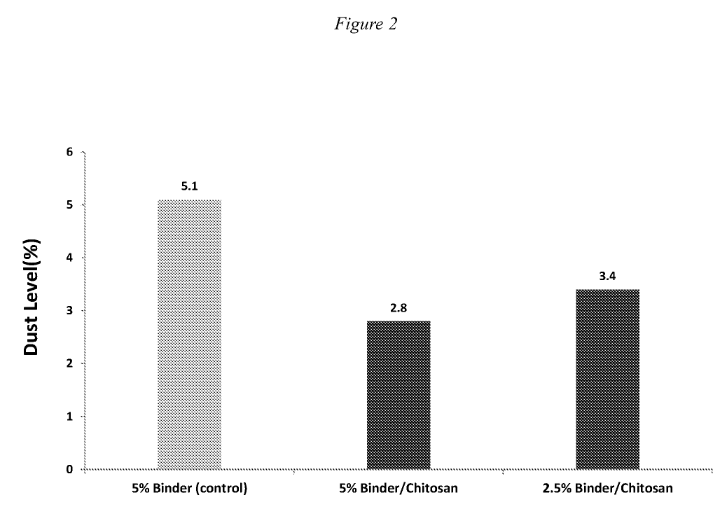

The data in FIG. 2 indicate that the dust level of nonwoven fabric treated with either 2.5 wt. % or 5 wt. % chitosan-latex binder (chitosan-VAE latex binder) was significantly lower than the dust level of nonwoven fabric treated with 5 wt. % conventional latex binder (VAE) without the chitosan. Nonwoven fabrics contain a characterized with high dust levels, which is major concern in the performance for converting of fabric. High dust can also create health issues. Since the blend chitosan-latex binder can significantly reduce dust level of nonwoven fabrics, this improvement can reduce the impact on the converting process as well as improved work environment and health.

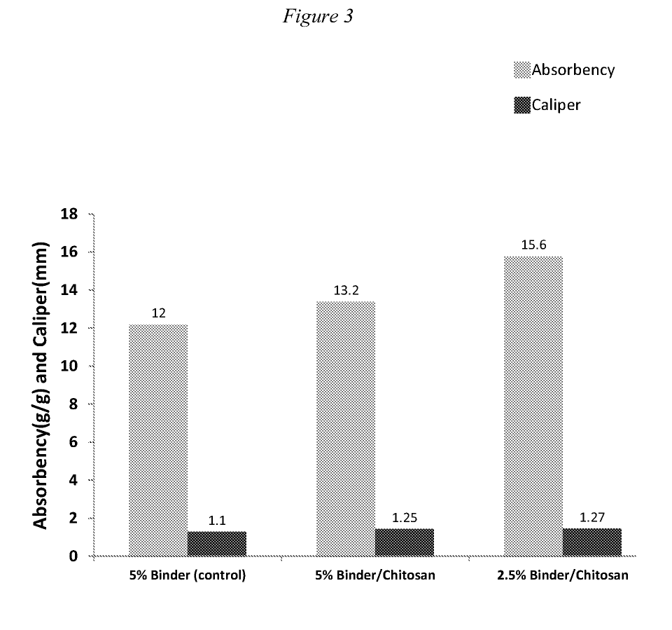

The data in FIG. 3 indicate that the water absorbency of nonwoven fabric treated with either 2.5 wt. % or 5 wt. % chitosan-latex binder (chitosan-VAE latex binder) was higher than the water absorbency of nonwoven fabric treated with 5 wt. % conventional latex binder (VAE) without the chitosan. The data in FIG. 3 further show that the caliper of nonwoven fabric treated with either 2.5 wt. or 5 wt. % chitosan-latex binder (chitosan-VAE latex binder) was higher than the caliper of nonwoven fabric treated with 5 wt. % conventional latex binder (VAE) without the chitosan.

### Example 2

MBAL (multi bond) nonwoven fabric was machine produced (Pilot Plant) by an airlaid process. The properties of the MBAL nonwoven fabric were tested and the data are displayed in Table 1. The fabric was prepared with pulp fiber, bicomponent fiber, and chitosan-latex binder.

TABLE 1

| | | | | | | | | | | Wet |
|---|---|---|---|---|---|---|---|---|---|---|
| | | | | | | | | | | Resiliency |
| | | | | | | | | | | 24 hr |
| | Avg. | | Average Tensile | | | | | | Avg. | Lotioned |
| | Basic | Avg. | Dry | | Wet | | | | Dust | Stack |
| Latex | Weight | Caliper | MD | CD | MD | CD | Absorbency | | Level | Height |
| Binder | (gsm) | (mm) | (gli) | (gli) | (gli) | (gli) | (g/gm) | Brightness | (%) | (cm) |
| 5% Binder | 60 | 1.1 | 653 | 564 | 289 | 229 | 12.0 | 84.6 | 5.4 | 7.8 |
| (control) | | | | | | | | | | |
| 3.5% | 60 | 1.2 | 660 | 663 | 244 | 210 | 13.0 | 84.8 | 4.1 | 8.5 |
| Binder/Chitosan | | | | | | | | | | |
| 2.5% | 60 | 1.2 | 702 | 594 | 237 | 203 | 15.0 | 85.6 | 4.3 | 8.4 |
| Binder/Chitosan | | | | | | | | | | |

The data in Table 1 indicate that the dry tensile strength and absorbency of MBAL nonwoven fabric treated with either 2.5 wt. % or 3.5 wt. % chitosan-latex binder was higher than the dry tensile strength and absorbency, respectively of MBAL nonwoven fabric treated with 5 wt. % conventional latex binder without the chitosan. The data in Table 1 further show that the dust level of MBAL nonwoven fabric treated with either 2.5 wt. % or 3.5 wt. % chitosan-latex binder was lower than the dust level of MBAL nonwoven fabric treated with 5 wt. % conventional latex binder without the chitosan.

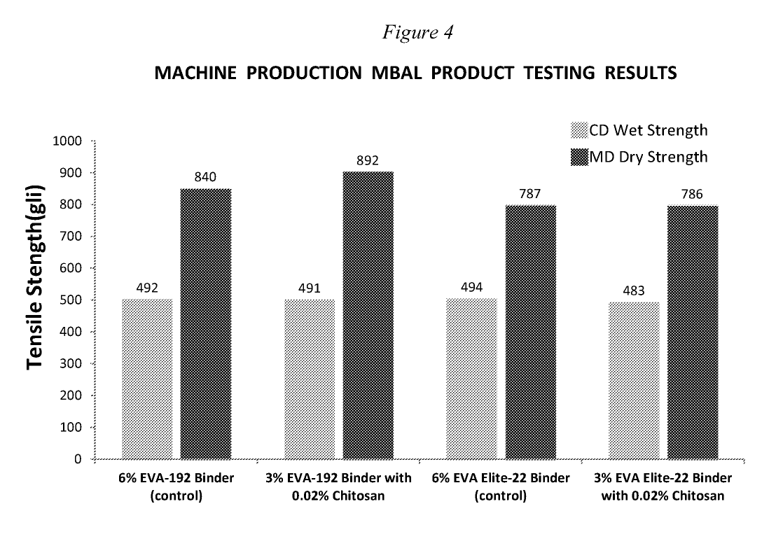

Machine production MBAL product testing results are shown in FIG. 4 showing the effect of tensile strength on chitosan addition into latex binder with MBAL nonwoven fabric. The testing results indicating that both tensile strength of machine production nonwoven fabric such as 6% binder addition (control) and 3% binder with 0.02% chitosan addition were almost the same. This result also indicated that only 0.02% addition of chitosan may save about 50% latex binder which will provide significantly reduced production cost of nonwoven fabrics as well as reduced environmental concern due to reduction in volatile latex binder.

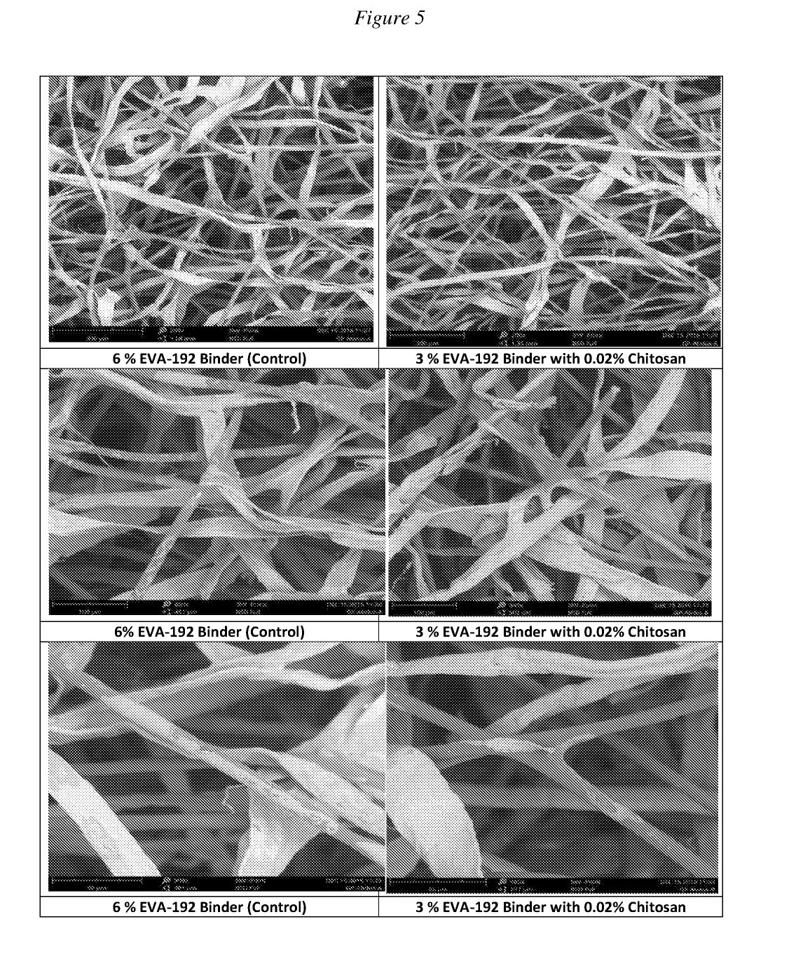

FIG. 5 displays an SEM Image of EVA-192 binder addition for a control sample (left) and EVA-192 binder with chitosan addition for an experimental sample (right) of machine production MBAL nonwoven fabrics. It is shown that the experimental sample has a very less amount of binder on the surface as well as a very smooth surface compared to control sample.

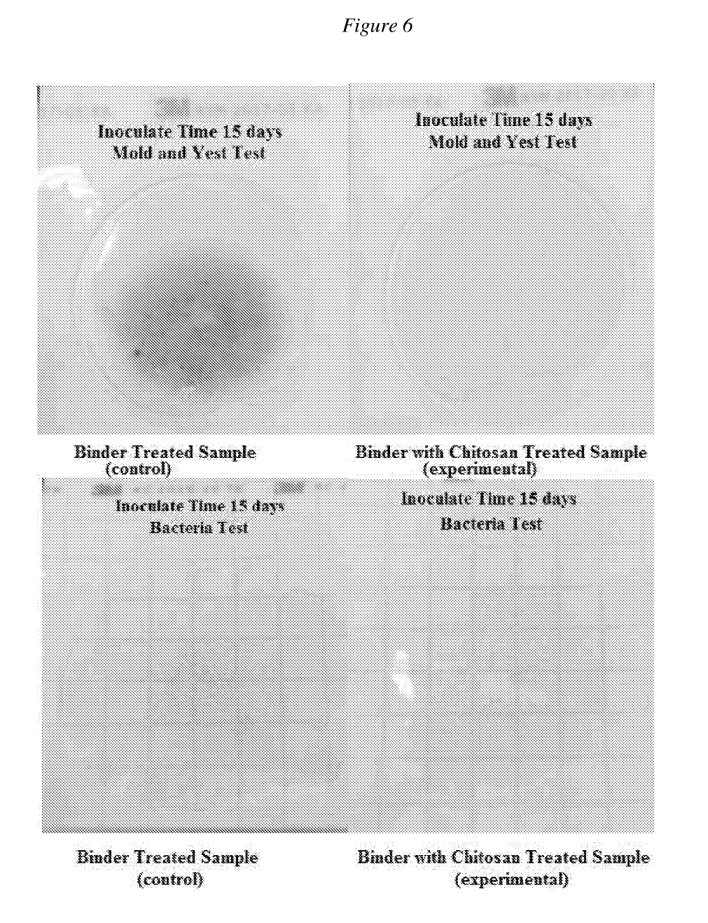

FIG. 6 displays the antimicrobial test of 6% binder addition (left) and 3% binder with chitosan addition (right) treated nonwoven fabric. Letheen Broth was used to inoculate the mold and bacteria in incubator at 37° C. for 15 days. The chitosan blended binder treated sample did not display any mold or bacteria but control sample did display mold and bacteria.

### Example 3

LBAL (latex bond) nonwoven fabric was machine produced (Pilot Plant) by an airlaid process. The properties of the LBAL nonwoven fabric were tested and the data are displayed in Table 2. The nonwoven fabric was prepared with pulp fiber, and chitosan-latex binder.

TABLE 2

| | | | | | | | | | | Wet |
|---|---|---|---|---|---|---|---|---|---|---|
| | | | | | | | | | | Resiliency |
| | | | | | | | | | | 24 hr |
| | Avg. | | Average Tensile | | | | | | Avg. | Lotioned |
| | Basic | Avg. | Dry | | Wet | | | | Dust | Stack |
| Latex | Weight | Caliper | MD | CD | MD | CD | Absorbency | | Level | Height |
| Binder | (gsm) | (mm) | (gli) | (gli) | (gli) | (gli) | (g/gm) | Brightness | (%) | (cm) |
| 13.1% | 60 | 0.35 | 1420 | 1193 | 600 | 482 | 9.0 | 82.7 | 4.52 | 5.5 |
| Binder | | | | | | | | | | |
| (control) | | | | | | | | | | |
| 9.1% | 60 | 0.41 | 1405 | 1175 | 702 | 652 | 8.9 | 84.6 | 0.97 | 4.5 |
| Binder/Chitosan | | | | | | | | | | |

The data in Table 2 indicate that the wet tensile strength of LBAL nonwoven fabric treated with 9.1 wt. % chitosan-latex binder was significantly higher than the wet tensile strength of LBAL nonwoven fabric treated with 13.1 wt. % conventional latex binder without the chitosan. The data in Table 2 further show that the dust level of LBAL nonwoven fabric treated with 9.1 wt. % chitosan-latex binder was significantly lower than the dust level of LBAL nonwoven fabric treated with 13.1 wt. % conventional latex binder without the chitosan.

For the purpose of any U.S. national stage filing from this application, all publications and patents mentioned in this disclosure are incorporated herein by reference in their entireties, for the purpose of describing and disclosing the constructs and methodologies described in those publications, which might be used in connection with the methods of this disclosure. Any publications and patents discussed herein are provided solely for their disclosure prior to the filing date of the present application. Nothing herein is to be construed as an admission that the inventors are not entitled to antedate such disclosure by virtue of prior invention.

In any application before the United States Patent and Trademark Office, the Abstract of this application is provided for the purpose of satisfying the requirements of 37 C.F.R. § 1.72 and the purpose stated in 37 C.F.R. § 1.72(b) “to enable the United States Patent and Trademark Office and the public generally to determine quickly from a cursory inspection the nature and gist of the technical disclosure.” Therefore, the Abstract of this application is not intended to be used to construe the scope of the claims or to limit the scope of the subject matter that is disclosed herein. Moreover, any headings that can be employed herein are also not intended to be used to construe the scope of the claims or to limit the scope of the subject matter that is disclosed herein. Any use of the past tense to describe an example otherwise indicated as constructive or prophetic is not intended to reflect that the constructive or prophetic example has actually been carried out.

The present disclosure is further illustrated by the following examples, which are not to be construed in any way as imposing limitations upon the scope thereof. On the contrary, it is to be clearly understood that resort can be had to various other aspects, embodiments, modifications, and equivalents thereof which, after reading the description herein, can be suggest to one of ordinary skill in the art without departing from the spirit of the present invention or the scope of the appended claims.

### ADDITIONAL DISCLOSURE

A first embodiment, which is a chitosan-latex binder comprising chitosan and latex binder in a weight ratio of chitosan to latex binder of from about 1:10 to about 1:15,000.

A second embodiment, which is the chitosan-latex binder of the first embodiment, wherein the chitosan-latex binder comprises the chitosan in an amount of from about 0.01 wt. % to about 1.0 wt. %.

A third embodiment, which is the chitosan-latex binder of any one of the first and the second embodiments, wherein the chitosan-latex binder comprises the latex binder in an amount of from about 99.0 wt. % to about 99.99 wt. %.

A fourth embodiment, which is the chitosan-latex binder of any one of the first through the third embodiments, wherein the chitosan-latex binder comprises water.

A fifth embodiment, which is the chitosan-latex binder of the fourth embodiment, wherein the chitosan-latex binder is a sprayable emulsion.

A sixth embodiment, which is the chitosan-latex binder of any one of the first through the fifth embodiments, wherein the chitosan-latex binder has a pH of from about 2 to about 6.

A seventh embodiment, which is the chitosan-latex binder of any one of the first through the sixth embodiments, wherein the latex is selected from the group consisting of vinyl acetate ethylene binders, vinyl acetate ethylene-N-methylol acrylamide binders, acrylic binders, vinyl acrylic binders, styrene acrylic binders, acrylic-polyurethane binders, styrene-butadiene binders, carboxylated styrene-butadiene binders, and combinations thereof.

An eighth embodiment, which is the chitosan-latex binder of any one of the first through the seventh embodiments, wherein the chitosan-latex binder comprises at least one antimicrobial agent.

A ninth embodiment, which is the chitosan-latex binder of the eighth embodiment, wherein the at least one antimicrobial agent comprises chitosan.

A tenth embodiment, which is a method of making a chitosan-latex binder, the method comprising (a) contacting chitosan with an acidic solution to form a chitosan solution; and (b) contacting at least a portion of the chitosan solution with a latex binder to form the chitosan-latex binder, wherein the chitosan-latex binder is characterized by a chitosan to latex binder weight ratio of from about 1:10 to about 1:15,000.

An eleventh embodiment, which is the method of the tenth embodiment, wherein the acidic solution comprises an acid in an amount of from about 0.1 wt. % to about 5 wt. %.

A twelfth embodiment, which is the method of any one of the tenth and the eleventh embodiments, wherein the acid comprises acetic acid, hydrochloric acid, citric acid, lactic acid, formic acid, adipic acid, malic acid, propionic acid, succinic acid, oxalic acid, thiolic acid, hydrofluoric acid, hydrobromic acid, or combinations thereof.

A thirteenth embodiment, which is the method of any one of the tenth through the twelfth embodiments, wherein the acidic solution has a pH of from about 1 to about 5.

A fourteenth embodiment, which is the method of any one of the tenth through the thirteenth embodiments, wherein the chitosan solution comprises chitosan in an amount of from about 0.1 wt. % to about 5 wt. %.

A fifteenth embodiment, which is the method of any one of the tenth through the fourteenth embodiments, wherein the step (a) of contacting chitosan with an acidic solution further comprises mixing, agitating, stirring, shaking, or combinations thereof.

A sixteenth embodiment, which is the method of any one of the tenth through the fifteenth embodiments, wherein the step (a) of contacting chitosan with an acidic solution further comprises heating to an ambient temperature.

A seventeenth embodiment, which is the method of any one of the tenth through the sixteenth embodiments, wherein the latex binder is an emulsion.

An eighteenth embodiment, which is the method of any one of the tenth through the sixteenth embodiments, wherein the latex binder is a powder.

A nineteenth embodiment, which is the method of any one of the tenth through the eighteenth embodiments, wherein the step (b) of contacting the chitosan solution with a latex binder further comprises mixing, agitating, stirring, shaking, or combinations thereof.

A twentieth embodiment, which is the method of any one of the tenth through the seventeenth embodiments, wherein the step (b) of contacting the chitosan solution with a latex binder comprises adding the chitosan solution to the latex binder under agitation, wherein the latex binder is an emulsion.

A twenty-first embodiment, which is the method of any one of the tenth through the nineteenth embodiments, wherein the step (b) of contacting the chitosan solution with a latex binder comprises adding the latex binder to the chitosan solution under agitation, wherein the latex binder is a powder, an emulsion, or both.

A twenty-second embodiment, which is a method of making a nonwoven fabric, the method comprising (a) forming a plurality of fibers into a fiber web; (b) contacting at least a portion of the fiber web with a chitosan-latex binder to form a binder impregnated fiber web, wherein the chitosan-latex binder comprises chitosan and latex binder in a weight ratio of chitosan to latex binder of from about 1:10 to about 1:15,000; and (c) curing the binder impregnated fiber web to form the nonwoven fabric.

A twenty-third embodiment, which is the method of the twenty-second embodiment, wherein the nonwoven fabric comprises a cured chitosan-latex binder, and wherein the cured chitosan-latex binder comprises at least a portion of the chitosan of the chitosan-latex binder and at least a portion of the latex binder of the chitosan-latex binder.

A twenty-fourth embodiment, which is the method of any one of the twenty-second and the twenty-third embodiments, wherein the step (a) of forming a plurality of fibers into a fiber web is a wet laid process.

A twenty-fifth embodiment, which is the method of any one of the twenty-second and the twenty-third embodiments, wherein the step (a) of forming a plurality of fibers into a fiber web is a dry laid process.

A twenty-sixth embodiment, which is the method of the twenty-fifth embodiment, wherein the dry laid process comprises an air-laid process.

A twenty-seventh embodiment, which is the method of any one of the twenty-second through the twenty-sixth embodiments, wherein the plurality of fibers comprises cellulosic fibers, synthetic fibers, or both.

A twenty-eighth embodiment, which is the method of the twenty-seventh embodiment, wherein the synthetic fibers comprise bicomponent and/or multicomponent fibers.

A twenty-ninth embodiment, which is the method of any one of the twenty-second through the twenty-eighth embodiments, wherein the step (b) of contacting the fiber web with a chitosan-latex binder comprises spraying the chitosan-latex binder onto the fiber web.

A thirtieth embodiment, which is the method of any one of the twenty-second through the twenty-ninth embodiments, wherein the fiber web and the chitosan-latex binder are contacted at a fabric to liquor ratio of from about 1:0.01 to about 1:10, wherein the fabric to liquor ratio is a mass to volume ratio expressed in kg fiber web to liters of chitosan-latex binder.

A thirty-first embodiment, which is the method of any one of the twenty-second through the thirtieth embodiments, wherein the step (c) of curing the binder impregnated fiber web comprises heating the binder impregnated fiber web to a temperature of from about 120° C. to about 225° C.

A thirty-second embodiment, which is the method of the twenty-eighth embodiment, wherein the step (c) of curing the binder impregnated fiber web comprises chemical and thermal bonding, wherein the bicomponent fibers comprise a core and a sheath surrounding the core, and wherein at least a portion of the sheath melts during the thermal bonding and provides for further bonding of the fiber web.

A thirty-third embodiment, which is the method of the thirty-second embodiment, wherein the thermal bonding comprises calendering, through-air thermal bonding, radiant heat bonding, sonic bonding, or combinations thereof.

A thirty-fourth embodiment, which is a nonwoven fabric comprising a fiber web in an amount of from about 85 wt. % to about 99.9 wt. %, based on the total weight of the nonwoven fabric; and a cured chitosan-latex binder in an amount of from about 0.1 wt. % to about 15 wt. %, based on the total weight of the nonwoven fabric, wherein the cured chitosan-latex binder comprises chitosan and latex binder in a weight ratio of chitosan to latex binder of from about 1:10 to about 1:15,000.

A thirty-fifth embodiment, which is the nonwoven fabric of the thirty-fourth embodiment, wherein the fiber web comprises cellulosic fibers, synthetic fibers, or both.

A thirty-sixth embodiment, which is the nonwoven fabric of any one of the thirty-fourth and the thirty-fifth embodiments, wherein the fiber web comprises cellulosic fibers in an amount of from about 50 wt. % to about 90 wt. %, and bicomponent fibers in an amount of from about 5 wt. % to about 45 wt. %, based on the total weight of the fiber web.

A thirty-seventh embodiment, which is the nonwoven fabric of the thirty-sixth embodiment, wherein the bicomponent fibers have a partially drawn core.

A thirty-eighth embodiment, which is the nonwoven fabric of any one of the thirty-fourth through the thirty-seventh embodiments, wherein the nonwoven fabric comprises the cured chitosan-latex binder in an amount of from about 0.1 g/m² to about 12 g/m², based on the surface area of the nonwoven fabric.

A thirty-ninth embodiment, which is the nonwoven fabric of any one of the thirty-fourth through the thirty-eighth embodiments, wherein the nonwoven fabric is characterized by a dry tensile strength measured in the machine direction of equal to or greater than about 400 grams per linear inch (gli), as determined in accordance with EDANA 20.2-89.

A fortieth embodiment, which is the nonwoven fabric of any one of the thirty-fourth through the thirty-ninth embodiments, wherein the nonwoven fabric is characterized by a dry tensile strength measured in the machine direction which is increased by equal to or greater than about 50% when compared to a dry tensile strength measured in the machine direction of an otherwise similar nonwoven fabric that has been treated with the same latex binder without the chitosan, and wherein the tensile strength is determined in accordance with EDANA 20.2-89.

A forty-first embodiment, which is the nonwoven fabric of any one of the thirty-fourth through the fortieth embodiments, wherein the nonwoven fabric is characterized by a wet tensile strength measured in the cross direction of equal to or greater than about 400 grams per linear inch (gli), as determined in accordance with EDANA 20.2-89.

A forty-second embodiment, which is the nonwoven fabric of any one of the thirty-fourth through the forty-first embodiments, wherein the nonwoven fabric is characterized by a wet tensile strength measured in the cross direction which is increased by equal to or greater than about 105% when compared to a wet tensile strength measured in the cross direction of an otherwise similar nonwoven fabric that has been treated with the same latex binder without the chitosan, and wherein the tensile strength is determined in accordance with EDANA 20.2-89.

A forty-third embodiment, which is the nonwoven fabric of any one of the thirty-fourth through the forty-second embodiments, wherein the nonwoven fabric is characterized by a dust level of less than about 5 wt. %, based on the total weight of the nonwoven fabric.

A forty-fourth embodiment, which is the nonwoven fabric of any one of the thirty-fourth through the forty-third embodiments, wherein the nonwoven fabric is characterized by a dust level which is decreased by equal to or greater than about 45% when compared to a dust level of an otherwise similar nonwoven fabric that has been treated with the same latex binder without the chitosan.

A forty-fifth embodiment, which is the nonwoven fabric of any one of the thirty-fourth through the forty-fourth embodiments, wherein the nonwoven fabric is characterized by a caliper of equal to or greater than about 0.1 mm, as determined in accordance with EDANA 30.5-99.

A forty-sixth embodiment, which is the nonwoven fabric of any one of the thirty-fourth through the forty-fifth embodiments, wherein the nonwoven fabric is characterized by a caliper which is increased by equal to or greater than about 10% when compared to a caliper of an otherwise similar nonwoven fabric that has been treated with the same latex binder without the chitosan, and wherein the caliper is determined in accordance with EDANA 30.5-99.

A forty-seventh embodiment, which is the nonwoven fabric of any one of the thirty-fourth through the forty-sixth embodiments, wherein the nonwoven fabric is characterized by a water absorbency of equal to or greater than about 1.2 grams of water per gram of nonwoven fabric (g/gm), as determined in accordance with EDANA 10.3-99.

A forty-eighth embodiment, which is the nonwoven fabric of any one of the thirty-fourth through the forty-seventh embodiments, wherein the nonwoven fabric is characterized by a water absorbency which is increased by equal to or greater than about 10% when compared to a water absorbency of an otherwise similar nonwoven fabric that has been treated with the same latex binder without the chitosan, and wherein the water absorbency is determined in accordance with EDANA 10.3-99.

A forty-ninth embodiment, which is the nonwoven fabric of any one of the thirty-fourth through the forty-eighth embodiments, wherein the nonwoven fabric treated with 2.5 wt. % chitosan-latex binder is characterized by a dry tensile strength that is increased by equal to or greater than about 40% when compared to a tensile strength of an otherwise similar nonwoven fabric that has been treated with 5 wt. % of the same latex binder without the chitosan, and wherein the tensile strength is determined in accordance with EDANA 20.2-89.

A fiftieth embodiment, which is the nonwoven fabric of any one of the thirty-fourth through the forty-ninth embodiments, wherein the nonwoven fabric treated with 2.5 wt. % chitosan-latex binder is characterized by a dust level that is decreased by equal to or greater than about 30% when compared to a dust level of an otherwise similar nonwoven fabric that has been treated with 5 wt. % of the same latex binder without the chitosan.

A fifty-first embodiment, which is the nonwoven fabric of any one of the thirty-fourth through the fiftieth embodiments, wherein the nonwoven fabric treated with 2.5 wt. % chitosan-latex binder is characterized by a caliper that is increased by equal to or greater than about 15% when compared to a caliper of an otherwise similar nonwoven fabric that has been treated with 5 wt. % of the same latex binder without the chitosan, and wherein the caliper is determined in accordance with EDANA 30.5-99.

A fifty-second embodiment, which is the nonwoven fabric of any one of the thirty-fourth through the fifty-first embodiments, wherein the nonwoven fabric treated with 2.5 wt. % chitosan-latex binder is characterized by a water absorbency that is increased by equal to or greater than about 25% when compared to a water absorbency of an otherwise similar nonwoven fabric that has been treated with 5 wt. % of the same latex binder without the chitosan, and wherein the water absorbency is determined in accordance with EDANA 10.3-99.

A fifty-third embodiment, which is an article comprising the nonwoven fabric of any one of the thirty-fourth through the fifty-second embodiments.

A fifty-fourth embodiment, which is the article of the fifty-third embodiment, wherein the article is selected from the group consisting of wipes, tissues, towels, medical drapes, bandages, caps, face masks, surgical scrubs, medical gowns, filters, diapers, padding, packaging, insulation, carpeting, upholstery, fabric dryer sheets, disposable textiles, earphone protection covers, insulation, wall coverings, and combinations thereof.

A fifty-fifth embodiment, which is a nonwoven fibrous material chemically bound with a latex binder modified with chitosan.

While embodiments of the disclosure have been shown and described, modifications thereof can be made without departing from the spirit and teachings of the invention. The embodiments and examples described herein are exemplary only, and are not intended to be limiting. Many variations and modifications of the invention disclosed herein are possible and are within the scope of the invention.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the detailed description of the present invention. The disclosures of all patents, patent applications, and publications cited herein are hereby incorporated by reference.

1-21. (canceled)

22. A method of making a nonwoven fabric, the method comprising:
(a) forming a plurality of fibers into a fiber web;
(b) contacting at least a portion of the fiber web with a chitosan-latex binder to form a binder impregnated fiber web, wherein the chitosan-latex binder comprises chitosan and latex binder in a weight ratio of chitosan to latex binder of from about 1:10 to about 1:15,000; and
(c) curing the binder impregnated fiber web to form the nonwoven fabric.

23-33. (canceled)

34. A nonwoven fabric comprising a fiber web in an amount of from about 85 wt. % to about 99.9 wt. %, based on the total weight of the nonwoven fabric; and a cured chitosan-latex binder in an amount of from about 0.1 wt. % to about 15 wt. %, based on the total weight of the nonwoven fabric, wherein the cured chitosan-latex binder comprises chitosan and latex binder in a weight ratio of chitosan to latex binder of from about 1:10 to about 1:15,000.

35. The nonwoven fabric of claim 34, wherein the fiber web comprises cellulosic fibers, synthetic fibers, or both.

36. The nonwoven fabric of claim 34, wherein the fiber web comprises cellulosic fibers in an amount of from about 50 wt. % to about 90 wt. %, and bicomponent fibers in an amount of from about 5 wt. % to about 45 wt. %, based on the total weight of the fiber web.

37. The nonwoven fabric of claim 36, wherein the bicomponent fibers have a partially drawn core.

38. The nonwoven fabric of claim 34, wherein the nonwoven fabric comprises the cured chitosan-latex binder in an amount of from about 0.1 g/m² to about 12 g/m², based on the surface area of the nonwoven fabric.

39. The nonwoven fabric of claim 34, wherein the nonwoven fabric is characterized by a dry tensile strength measured in the machine direction of equal to or greater than about 400 grams per linear inch (gli), as determined in accordance with EDANA 20.2-89.

40. The nonwoven fabric of claim 34, wherein the nonwoven fabric is characterized by a dry tensile strength measured in the machine direction which is increased by equal to or greater than about 50% when compared to a dry tensile strength measured in the machine direction of an otherwise similar nonwoven fabric that has been treated with the same latex binder without the chitosan, and wherein the tensile strength is determined in accordance with EDANA 20.2-89.

41. The nonwoven fabric of claim 34, wherein the nonwoven fabric is characterized by a wet tensile strength measured in the cross direction of equal to or greater than about 400 grams per linear inch (gli), as determined in accordance with EDANA 20.2-89.

42. The nonwoven fabric of claim 34, wherein the nonwoven fabric is characterized by a wet tensile strength measured in the cross direction which is increased by equal to or greater than about 105% when compared to a wet tensile strength measured in the cross direction of an otherwise similar nonwoven fabric that has been treated with the same latex binder without the chitosan, and wherein the tensile strength is determined in accordance with EDANA 20.2-89.

43. The nonwoven fabric of claim 34, wherein the nonwoven fabric is characterized by a dust level of less than about 5 wt. %, based on the total weight of the nonwoven fabric.

44. The nonwoven fabric of claim 34, wherein the nonwoven fabric is characterized by a dust level which is decreased by equal to or greater than about 45% when compared to a dust level of an otherwise similar nonwoven fabric that has been treated with the same latex binder without the chitosan.

45. The nonwoven fabric of claim 34, wherein the nonwoven fabric is characterized by a caliper of equal to or greater than about 0.1 mm, as determined in accordance with EDANA 30.5-99.

46. The nonwoven fabric of claim 34, wherein the nonwoven fabric is characterized by a caliper which is increased by equal to or greater than about 10% when compared to a caliper of an otherwise similar nonwoven fabric that has been treated with the same latex binder without the chitosan, and wherein the caliper is determined in accordance with EDANA 30.5-99.

47. The nonwoven fabric of claim 34, wherein the nonwoven fabric is characterized by a water absorbency of equal to or greater than about 1.2 grams of water per gram of nonwoven fabric (g/gm), as determined in accordance with EDANA 10.3-99.

48. The nonwoven fabric of claim 34, wherein the nonwoven fabric is characterized by a water absorbency which is increased by equal to or greater than about 10% when compared to a water absorbency of an otherwise similar nonwoven fabric that has been treated with the same latex binder without the chitosan, and wherein the water absorbency is determined in accordance with EDANA 10.3-99.

49. The nonwoven fabric of claim 34, wherein the nonwoven fabric treated with 2.5 wt. % chitosan-latex binder is characterized by a dry tensile strength that is increased by equal to or greater than about 40% when compared to a tensile strength of an otherwise similar nonwoven fabric that has been treated with 5 wt. % of the same latex binder without the chitosan, and wherein the tensile strength is determined in accordance with EDANA 20.2-89.

50. The nonwoven fabric of claim 34, wherein the nonwoven fabric treated with 2.5 wt. % chitosan-latex binder is characterized by a dust level that is decreased by equal to or greater than about 30% when compared to a dust level of an otherwise similar nonwoven fabric that has been treated with 5 wt. % of the same latex binder without the chitosan.

51. The nonwoven fabric of claim 34, wherein the nonwoven fabric treated with 2.5 wt. % chitosan-latex binder is characterized by a caliper that is increased by equal to or greater than about 15% when compared to a caliper of an otherwise similar nonwoven fabric that has been treated with 5 wt. % of the same latex binder without the chitosan, and wherein the caliper is determined in accordance with EDANA 30.5-99.

52. The nonwoven fabric of claim 34, wherein the nonwoven fabric treated with 2.5 wt. % chitosan-latex binder is characterized by a water absorbency that is increased by equal to or greater than about 25% when compared to a water absorbency of an otherwise similar nonwoven fabric that has been treated with 5 wt. % of the same latex binder without the chitosan, and wherein the water absorbency is determined in accordance with EDANA 10.3-99.

53-55. (canceled)
